(19) United States
(12) Patent Application Publication
(10) Pub. No.: US 2026/0018953 A1
(43) Pub. Date: Jan. 15, 2026

(54) MOTOR, COMPRESSOR, AND METHOD OF MANUFACTURING A MOTOR

(71) Applicant: AICHI ELECTRIC CO., LTD., KASUGAI-SHI (JP)

(72) Inventors: Masahiro HASEGAWA, Kasugai-shi (JP); Yudai SUZUKI, Kasugai-shi (JP)

(21) Appl. No.: 19/262,395

(22) Filed: Jul. 8, 2025

(30) Foreign Application Priority Data
Jul. 9, 2024 (JP) 2024-110306
Jul. 9, 2024 (JP) 2024-110307

(51) Int. Cl. H02K 3/52; F25B 31/02; H02K 15/106

(52) U.S. Cl. CPC H02K 3/522; F25B 31/02; H02K 15/106; H02K 2203/12

(57) ABSTRACT

In an electric motor (310), an electrical insulation body (70) includes a first insulation part (71), a second insulation part (72), and a third insulation part (73). The third insulation part includes a first side surface insulation body (731) disposed on a first side surface of a tooth base part (842) of a stator tooth (84) on the first side in a circumferential direction (DX), a second side surface insulation body (732) disposed on a second side surface of the tooth base part of the stator tooth on a second side in the circumferential direction, and a connection part (733) that connects the first side surface insulation body and the second side surface insulation body. The connection part is disposed on the first side in the axial direction with respect to the tooth base part while being in contact with a first insulation part.

### CROSS-REFERENCE TO RELATED APPLICATIONS

This application claims priority to Japanese patent application nos. 2024-110306 and 2024-110307, both filed on Jul. 9, 2024, the contents of both of which are fully incorporated herein by reference.

### TECHNICAL FIELD

The present disclosure relates to a motor, a compressor, and a method of manufacturing a motor.

### BACKGROUND

Some known motors comprise a cylindrical segmented stator that is formed by annularly (circumferentially) joining a plurality of discrete stator segments. Each stator segment includes a stator core segment having a yoke part and a tooth part, an insulation member, and a winding (coil) wound around the tooth part via (over) the insulation member. The insulation member includes end surface insulators and slot insulators. Each of the winding is wound around the respective tooth part in a state in which the end surface insulators are disposed on the respective end portions of the stator core segment in the axial direction and the slot insulators are disposed on the respective side surfaces of the tooth part. For example, WO 2022/009521 discloses a technique in which slit portions are provided on one of the end surface insulators, and each of the windings is wound in a state in which the slot insulators are respectively inserted (held) between the slit portions and the stator core segment.

### SUMMARY

However, in the above-described prior art, the slot insulators are insufficiently secured to the stator core segment. That is, if the slot insulators are merely inserted between the respective slit portions and the stator core segment, the slot insulators may fall off the stator core segment when the winding is being wound around the stator core segment.

It is therefore one non-limiting object of the present teachings to disclose techniques for attaching an electrical insulation body to a stator core segment more securely.
(1) In one aspect of the present disclosure, an electric motor may include a segmented stator having a cylindrical shape extending in an axial direction, and a rotor rotatably disposed within the segmented stator. The segmented stator includes a plurality of stator core segments, each including a yoke segment that forms a yoke when the stator core segments are annularly (circumferentially) coupled one another, and a tooth base part extending radially inward from the yoke segment. An electrical insulation body is disposed on (attached to) each stator core segment, and a stator winding is wound around each stator core segment (in particular, around the tooth base part thereof) via (over) the electrical insulation body. Each electrical insulation body includes a first insulation part disposed at (on) a first axial end portion on a first side in the axial direction of the stator core segment, a second insulation part disposed at (on) a second axial end portion on a second side in the axial direction of the stator core segment, which is opposite to the first side in the axial direction, and a third insulation part configured to electrically insulate a first side surface of the tooth base part on a first side in a circumferential direction and a second side surface of the tooth base part on a second side in the circumferential direction from the stator winding, the second side surface being opposite to the first side surface in the circumferential direction. More specifically, the third insulation part may include a first side surface insulation body (sheet) disposed on the first side surface of the tooth base part, a second side surface insulation body (sheet) disposed on the second side surface of the tooth base part, and a connection part that connects the first side surface insulation body and the second side surface insulation body. The connection part of the third insulation part is disposed on the first axial side in the axial direction with respect to the tooth base part while being in contact with the first insulation part.

According to the motor of this aspect, since the connection part of the third insulation part (which covers the first and second side surfaces of the tooth base part) is supported (held, retained) by the first insulation part, the first side surface insulation body and the second side surface insulation body are much less likely to fall off the respective stator core segments during the manufacture of the segmented stator (in particular, while winding the stator windings (coils) on the respective stator core segments).
(2) In one embodiment of the motor according to the above-described aspect, the first insulation part may include a fitting part projecting toward the stator core segment. The first axial end portion on the first side in the axial direction of the stator core segment may include a fitting-receiving part corresponding (conforming, being complementary) to the fitting part; i.e. the fitting-receiving part is configured to receive (accommodate) the fitting part.

According to such a motor, the first insulation part can be secured to (held by) the stator core segment by simply fitting together (mating) the fitting part of the first insulation part and the fitting-receiving part of the stator core segment. Accordingly, by performing a simple method, the first insulation part can be impeded or even prevented from falling off the stator core segment during the manufacture of the segmented stator.
(3) In another embodiment of the motor according to the above-described aspect, the first insulation part may include a groove (channel, slot), the groove (channel, slot) having a recessed shape extending from an inner side in a radial direction toward an outer side in the radial direction of the first insulation part or a recessed shape extending from the outer side in the radial direction toward the inner side in the radial direction of the first insulation part, and penetrating through the first insulation part in the circumferential direction. The groove (channel, slot) is configured (designed) such that its depth in the radial direction is greater than its width in the circumferential direction (or perpendicular to the radial direction); e.g., the depth is preferably at least two times greater than the width, e.g., at least three times greater than the width. The connection part is disposed in the groove while being inserted through the first side in the circumferential direction to the second side in the circumferential direction of the groove so as to be disposed on the first axial side in the axial direction with respect to the tooth base part while being in contact with the first insulation part.

According to such a motor, by simply inserting (placing) the connection part into the groove, the first side surface insulation body and the second side surface insulation body can be impeded or even prevented from falling off the stator core segment during the manufacture of the segmented stator.
(4) In another embodiment of the motor according to the above-described aspect, the stator core segment may include a tooth tip part extending continuously to a radially-inward tip end of the tooth base part. The first insulation part may include an outer wall part disposed at (on) an (the first) end on the first side in the axial direction of the yoke segment, a drum part disposed at (on) an (the first) end on the first side in the axial direction of the tooth base part, and an inner wall part disposed at (on) an (the first) end on the first side in the axial direction of the tooth tip part. The inner wall part may include a first side projection, which is disposed at (on) an (a first) end portion on the first side in the circumferential direction of the inner wall part, projects toward the second side in the axial direction and contacts an end portion on the first side in the circumferential direction of the tooth tip part, and a second side projection, which is disposed at (on) an (a second) end portion on the second side in the circumferential direction of the inner wall part, projects toward the second side in the axial direction and contacts an end portion on the second side in the circumferential direction of the tooth tip part.

According to such a motor, the first insulation part can be restricted (blocked) or even prevented from rotating with respect (relative) to the stator core segment in the circumferential direction owing to the first side projection and the second side projection.
(5) In another embodiment of the motor according to the above-described aspect, the first insulation part may include a fitting part projecting toward the stator core segment. The (first axial) end portion on the first side in the axial direction of the stator core segment may include a fitting-receiving part corresponding to the fitting part.

According to such a motor, the first insulation part can be secured to (held by) the stator core segment by simply fitting together (mating) the fitting part of the first insulation part and the fitting-receiving part of the stator core segment. Accordingly, by performing a simple method, the first insulation part can be impeded or prevented from falling off the stator core segment during the manufacture of the segmented stator.
(6) In another embodiment of the motor according to the above-described aspect, the connection part may be disposed on an upper surface of the first insulation part so as to be disposed on the first side in the axial direction with respect to the tooth base part while being in contact with the first insulation part.

According to such a motor, the first side surface insulation body and the second side surface insulation body can be impeded or even prevented from falling off the stator core segment during the manufacture of the segmented stator by utilizing a relatively simple structure.
(7) In another embodiment of the motor according to the above-described aspect, the connection part may be disposed between the stator core segment and the first insulation part so as to be disposed on the first side in the axial direction with respect to the tooth base part while being in contact with the first insulation part.

According to such a motor as well, the first side surface insulation body and the second side surface insulation body can be impeded or even prevented from falling off the stator core segment during the manufacture of the segmented stator by utilizing a relatively simple structure.
(8) In another embodiment of the motor according to the above-described aspect, the stator core segment may include a tooth tip part extending continuously to a radially-inward tip end of the tooth base part. The tooth tip part may include a first flange extending from the tooth base part toward the first side in the circumferential direction, and a second flange extending from the tooth base part toward the second side in the circumferential direction. The first side surface insulation body may include a first wall part disposed to face (and preferably contact) a first inner peripheral surface of the yoke segment extending from the tooth base part toward the first side in the circumferential direction, a second wall part disposed to face (and preferably contact) an outer peripheral surface of the first flange, and a side wall part disposed to face (and preferably contact) the side surface of the tooth base part on the first side in the circumferential direction. The second side surface insulation body may include a first wall part disposed to face (and preferably contact) a second inner peripheral surface of the yoke segment extending from the tooth base part toward the second side in the circumferential direction, a second wall part disposed to face (and preferably contact) an outer peripheral surface of the second flange, and a side wall part disposed to face (and preferably contact) the side surface of the tooth base part on the second side in the circumferential direction.
(9) In another embodiment of the motor according to the above-described aspect, a center of the connection part in the radial direction may be disposed either radially outward or radially inward relative to a center of a side wall part of the first side surface insulation body in the radial direction, or radially outward or radially inward relative to a center of a side wall part of the second side surface insulation body in the radial direction.

According to such a motor, it is possible to reduce the likelihood of or even prevent manufacturing (assembly) errors such as the third insulation part being incorrectly disposed in the reverse orientation with respect to the stator core segment in the radial direction.
(10) In another aspect of the present disclosure, a compressor preferably includes a compression mechanism configured to compress a fluid and to output compressed fluid, and a motor configured to drive the compression mechanism. The motor may be designed according to any of the above-described and/or below-described aspects and embodiments of the present teachings.

Embodiments of the present disclosure can be realized in various aspects other than a motor or a compressor. For example, embodiments of the present disclosure can be realized as aspects including, but not limited to, a segmented stator, a method of manufacturing a segmented stator, a stator segment, a method of manufacturing a stator segment, a method of manufacturing a motor, and/or a method of manufacturing a compressor.

### BRIEF DESCRIPTION OF THE DRAWINGS

FIG. 1 is an explanatory cross-sectional view showing internal structures of a compressor equipped with a motor according to a first embodiment of the present teachings.

FIG. 2 is an explanatory view showing a configuration of a segmented stator used in the motor according to the first embodiment.

FIG. 3 is a sectional view showing cross-section III-III in FIG. 2.

FIG. 4 is an explanatory view showing an exterior configuration of a stator segment.

FIG. 5 is an explanatory view showing an exterior configuration of a stator core segment.

FIG. 6 is a plan view of the stator core segment of FIG. 5.

FIG. 7 is an explanatory view showing an exterior configuration of a second insulation part.

FIG. 8 is an explanatory view showing an exterior configuration of a first insulation part on a first side in the axial direction.

FIG. 9 is an explanatory view showing a configuration of a side surface of the first insulation part.

FIG. 10 is an explanatory view showing an exterior configuration of the first insulation part on a second side in the axial direction.

FIG. 11 is an explanatory view showing an exterior configuration of a third insulation part.

FIG. 12 is a plan view showing a configuration of the third insulation part on a first side in the axial direction (i.e., in a plan view).

FIG. 13 is a flow chart showing an exemplary motor manufacturing process.

FIG. 14 is an explanatory view showing an overview of an insertion step of the exemplary motor manufacturing process.

FIG. 15 is an explanatory view showing an overview of a winding step of the exemplary motor manufacturing process.

FIG. 16 is an explanatory view showing an exterior configuration of a first insulation part provided in a motor according to a second embodiment.

FIG. 17 is an explanatory view showing a configuration of a first side projection and a second side projection according to the second embodiment.

FIG. 18 is an explanatory view showing an exterior configuration of a stator segment provided in a motor according to a third embodiment.

FIG. 19 is an explanatory view showing a configuration of a third insulation part.

FIG. 20 is an explanatory view showing a configuration of an assembly.

FIG. 21 is an explanatory view showing an exterior configuration of a stator segment provided in a motor according to a fourth embodiment.

FIG. 22 is an explanatory view showing a configuration of a first insulation part according to the fourth embodiment.

FIG. 23 is an explanatory view showing a configuration of a fitting hole of a first modified example.

FIG. 24 is an explanatory view showing a configuration of a cutout of a second modified example.

FIG. 25 is an explanatory view showing a configuration of two fitting holes of the first insulation part according to the fifth embodiment, which serves as a third modified example.

FIG. 26 is a flow chart showing a modified example of the exemplary motor manufacturing process.

### DETAILED DESCRIPTION OF THE EMBODIMENTS

### A. First Embodiment

### A1. Configuration of Compressor 300 and Motor 310

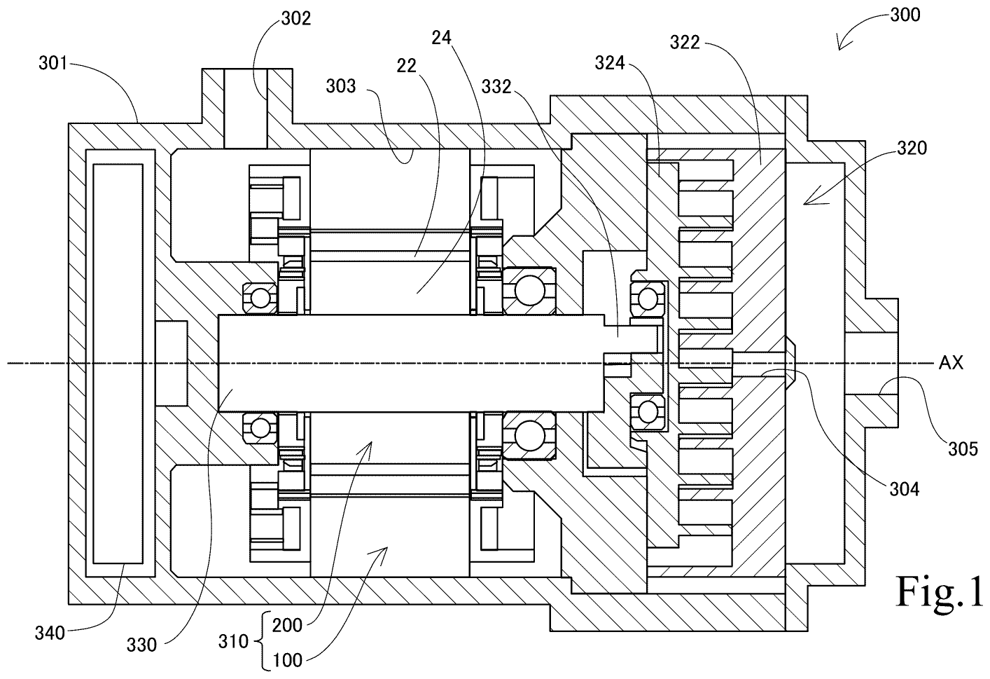

FIG. 1 is an explanatory view showing internal structures of a compressor 300 equipped with a motor 310 according to a first embodiment of the present disclosure. The compressor 300 is configured, for example, as an electric scroll compressor. For example, the compressor 300 may be installed, together with other components such as an evaporator, an expansion valve, a condenser, etc., in a vehicle (not shown in the drawings) to function as a refrigerant circuit (air conditioning system) of an in-vehicle air conditioner.

As shown in FIG. 1, the compressor 300 includes a housing 301, a motor 310, a compression mechanism 320 that compresses a fluid and outputs compressed fluid, a drive shaft 330, and a power source circuit (regulated power supply) 340. The housing 301 houses the motor 310 and the compression mechanism 320. An intake port 302, a motor chamber 303 in which the motor 310 is disposed, and a discharge port 305 are formed (defined) in the housing 301.

The intake port 302 is in fluid communication with the motor chamber 303. The intake port 302 is fluidly connected, for example, to an evaporator (not shown in the drawings), receives the refrigerant supplied from the evaporator, and guides the refrigerant to flow into the motor chamber 303. The discharge port 305 discharges pressurized refrigerant compressed by the compression mechanism 320 to the outside of the compressor 300. The discharge port 305 is fluidly connected, for example, to a condenser (not shown in the drawings).

The drive shaft 330 is a substantially cylindrical member extending along a rotational axis AX. The drive shaft 330 is supported inside the housing 301 so as to be rotatable around the rotational axis AX. An eccentric pin 332 having a substantially cylindrical shape is formed at (extends from) an end portion of the drive shaft 330. The eccentric pin 332 is arranged at a position offset by a predetermined distance from the rotational axis AX.

The motor 310 generates a driving force to rotate the drive shaft 330 around the rotational axis AX. The motor 310 is an example of an “electric motor” according to the present teachings. In the present embodiment, an example that uses an inner-rotor motor as the motor 310 will be described. The motor 310 includes a segmented stator 100 having a substantially cylindrical shape, and a rotor 200. The motor 310 may instead be an outer-rotor motor (i.e. the rotor is radially outside of (surrounding) the stator) in other embodiments of the present teachings.

The segmented stator 100 is fixedly positioned in the motor chamber 303. The segmented stator 100 (i.e. the windings (coils) thereof) is electrically connected to the power source circuit 340. The power source circuit 340 is, for example, an inverter or the like configured to supply control (driving) currents to energize the windings (coils) 90 of the motor 310.

The rotor 200 is disposed in the interior of the segmented stator 100, so as to be rotatable relative to the segmented stator 100. The rotor 200 includes a cylindrical rotor core 24, a plurality of magnets 22 fixed within (or to a surface of) the rotor core 24, and a drive shaft 330 fixed at (in) the center of the rotor core 24. The rotor core 24 is formed by stacking (laminating) iron core pieces formed of electrical steel sheets. The magnets 22 are permanent magnets containing, for example, neodymium, iron, boron, etc. Each magnet 22 has an elongated flat plate (rectangular) shape along the axial direction of the rotor core 24. The drive shaft 330 rotates around the rotational axis AX when the rotor 200 is rotated.

The compression mechanism 320 includes a fixed scroll 322 and a movable scroll 324. The movable scroll 324 is connected to the drive shaft 330 via the eccentric pin 332. The fixed scroll 322 is fixed to the housing 301. A fluid communication path 304 is formed in the fixed scroll 322. The fixed scroll 322 and the movable scroll 324 each have wall surface arranged in a helical shape, and the helically-shaped wall surfaces are arranged to mesh (to be interleaved) with each other. As a result, a compression chamber capable of compressing the refrigerant is formed between the fixed scroll 322 and the movable scroll 324. When the motor 310 is energized and the drive shaft 330 rotates around the rotational axis AX, the movable scroll 324 orbits (revolves) around the rotational axis AX, and the refrigerant in the compression chamber is compressed. The compressed refrigerant is supplied from the compression mechanism 320 to the discharge port 305 via the fluid communication path 304.

### A2. Configuration of Segmented Stator 100

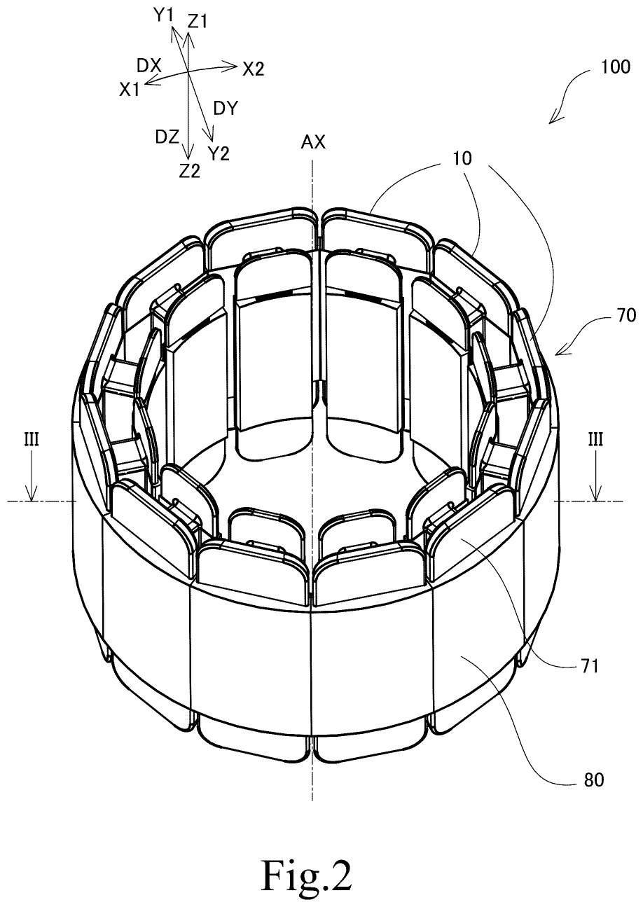

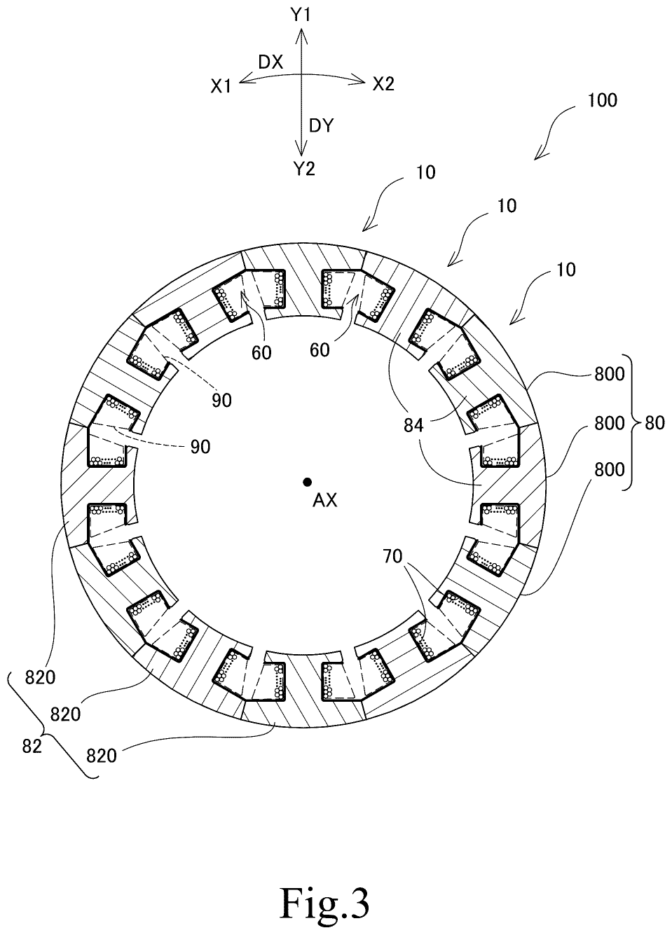

FIG. 2 is an explanatory view showing the configuration of the segmented stator 100 used in the motor 310 according to the first embodiment. Note that, in FIG. 2, for ease of understanding of the technology, stator windings (coils) 90 are not shown (such stator windings 90 are shown, e.g., in FIG. 3).

Several of the drawings, including FIG. 2, schematically show three directions used in the present disclosure. In these drawings, “axial direction DZ” refers to the axial direction of the rotational axis AX of the rotor 200, i.e. a direction that is parallel to or coincides with the rotational axis AX. In the axial direction DZ, the side on which a first insulation part 71 is disposed with respect to a stator core 80 is defined as “first side Z1 in the axial direction” or “first axial end” and the opposite side is defined as “second side Z2 in the axial direction” or “second axial end”. In a state in which the motor 310 is disposed with the rotational axis AX extending along the vertical direction, the first side Z1 in the axial direction may also be referred to as “upper side”, and the second side Z2 in the axial direction may also be referred to as “lower side”. “Circumferential direction DX” refers to the circumferential direction around the rotational axis AX. In the circumferential direction DX, when the motor 310 is viewed from the first side Z1 in the axial direction, the counterclockwise direction is defined as “first side X1 in the circumferential direction” and the clockwise direction is defined as “second side X2 in the circumferential direction”. “Radial direction(s) DY” pass(es) through (intersect(s)) the rotational axis AX, and is (are) orthogonal to the rotational axis AX. The term “radial direction DY” refers to a radial direction centered on (extending perpendicularly from) the rotational axis AX. In the radial direction DY, the side of the rotational axis AX with respect to a predetermined reference position is defined as “inner side Y2 in the radial direction” or “radially inward” and the opposite side is defined as “outer side Y1 in the radial direction” or “radially outward”.

As shown in FIG. 2, the segmented stator 100 includes a plurality of discrete stator segments 10, which have been joined together. In the example shown in FIG. 2, the segmented stator 100 includes twelve stator segments 10, although different numbers of stator segments 10 may be utilized in accordance with the application of the present teachings (i.e. the number of coils 90 utilized to rotatably drive the rotor 200). The segmented stator 100 is formed by annularly (circumferentially) coupling (affixing, e.g., welding) the plurality of stator segments 10 to form a hollow, substantially cylindrical shape.

FIG. 3 is a sectional view showing the cross-section III-III in FIG. 2. As shown in FIGS. 2 and 3, the segmented stator 100 includes the segmented stator core 80, electrical insulation bodies 70, and the stator windings 90.

The segmented stator core 80 includes a (segmented) yoke 82 extending in the circumferential direction DX, and a plurality of teeth 84 extending from the inner peripheral surface of the (segmented) yoke 82 toward the inner side Y2 in the radial direction (i.e. the teeth 84 extend radially inward). The segmented stator core 80 is formed by annularly (circumferentially) coupling (affixing, e.g., welding) a plurality of stator core segments 800.

As shown in FIG. 3, each stator core segment 800 includes a yoke segment 820 and a tooth 84. The yoke 82 is formed by annularly (circumferentially) coupling (affixing, e.g., welding) the plurality of yoke segments 820 to form a hollow, substantially cylindrical shape. In the present embodiment, one tooth 84 is provided for (on) each stator core segment 800, and thus the number of teeth 84 is equal to the number of stator core segments 800.

Portions of the stator windings 90 are respectively disposed in slots 60, as shown in FIG. 3. On each stator segment 10, the stator winding 90 is wound around the tooth 84 via (over, around) the respective electrical insulation body 70 by using a concentrated winding method, thereby forming a coil for each stator segment 10.

### A3. Configuration of Stator Segment 10

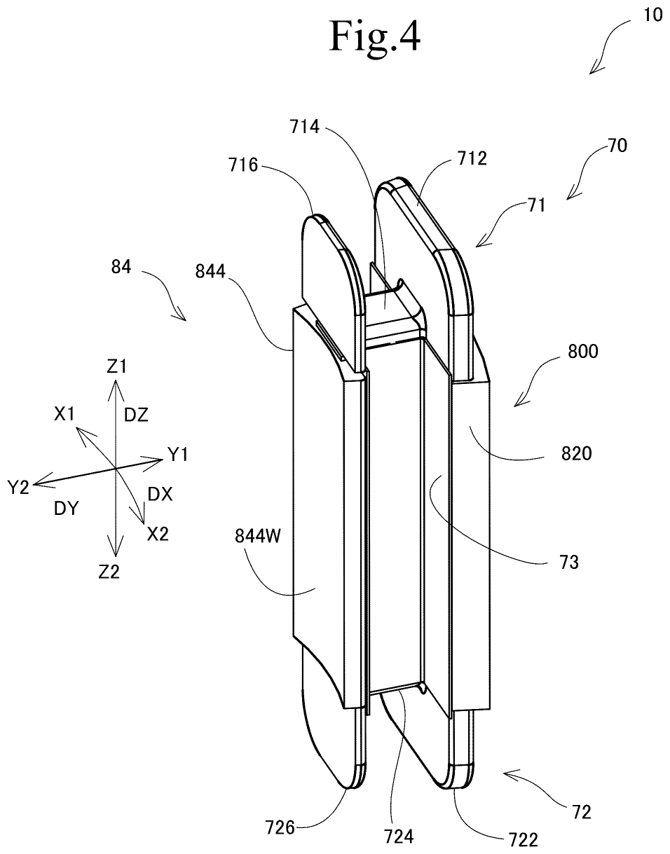

FIG. 4 is an explanatory view showing an exterior configuration (shape) of one of the stator segments 10. In the present embodiment, all of the stator segments 10 are preferably formed in an identical manner, but in alternate embodiments one or more of the stator segments 10 may be configured differently. Each stator segment 10 includes one of the stator core segments 800, one of the electrical insulation bodies 70, and one of the stator windings 90 (not shown in FIG. 4 for clarity purposes).

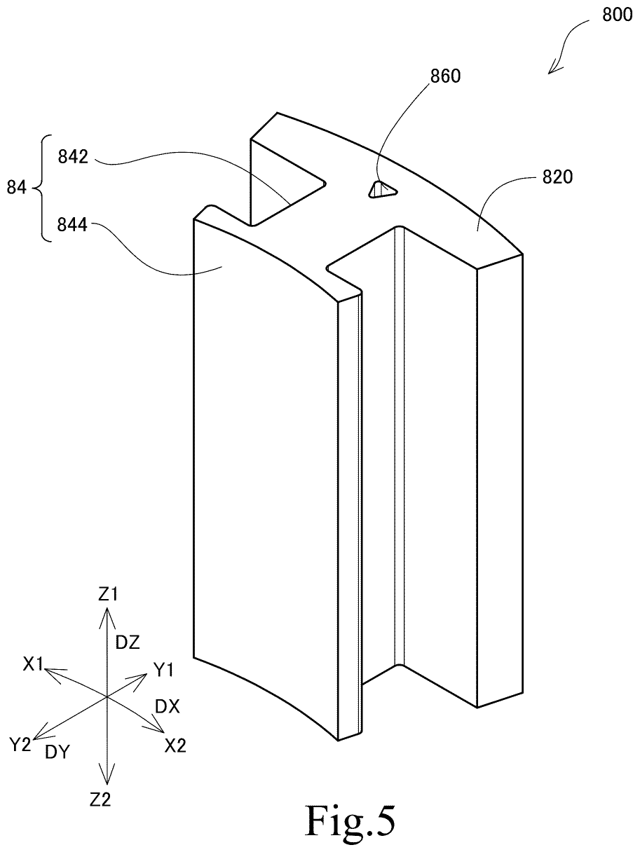

FIG. 5 is an explanatory view showing an exterior configuration (shape) of one of the stator core segment 800. In the present embodiment, all of the stator core segments 800 are preferably formed in an identical manner, but in alternate embodiments one or more of the stator core segments 800 may be configured differently. Each stator core segment 800 is formed by stacking (laminating) a plurality of electrical steel sheets. Each stator core segment 800 includes the yoke segment 820, the tooth 84, and a (at least one) fitting hole 860. The tooth 84 extends from the inner peripheral surface on the inner side Y2 in the radial direction of the yoke segment 820 toward the inner side Y2 in the radial direction (i.e. radially inward). Each tooth 84 includes a tooth base part 842 and a tooth tip part 844.

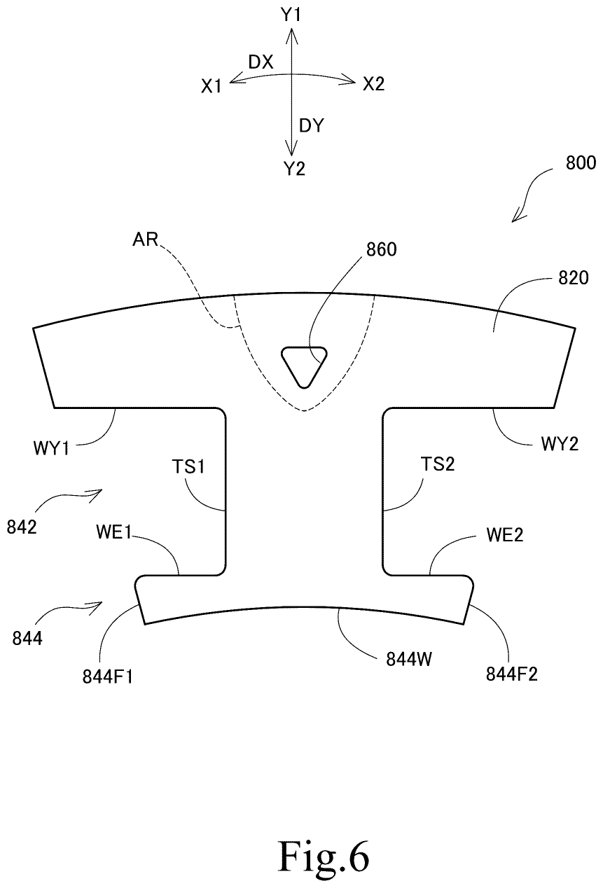

FIG. 6 is a plan view of the stator core segment 800 shown in FIG. 5. The tooth base part 842 extends from the inner peripheral surface on the inner side Y2 in the radial direction of the yoke segment 820 toward the inner side Y2 in the radial direction; i.e. the tooth base part 842 extends radially inward from the yoke segment 820. The tooth base part 842 has a first side surface TS1 on the first side X1 in the circumferential direction and a second side surface TS2 on the second side X2 in the circumferential direction. The portion of the inner peripheral surface on the inner side Y2 in the radial direction of the yoke segment 820 that extends from the tooth base part 842 toward the first side X1 in the circumferential direction and continues to the first side surface TS1 is also referred to as “first inner peripheral surface WY1”. Further, the portion of the inner peripheral surface that extends from the tooth base part 842 toward the second side X2 in the circumferential direction and continues to the second side surface TS2 is also referred to as “second inner peripheral surface WY2”.

The tooth tip part 844 extends continuously to a tip end of the tooth base part 842 on the inner side Y2 in the radial direction (i.e. to the radially-inward tip end of the tooth base part 842). As shown in FIG. 6, the tooth tip part 844 includes a first flange 844F1 extending from the tip end of the tooth base part 842 toward the first side X1 in the circumferential direction, and a second flange 844F2 extending from the tip end of the tooth base part 842 toward the second side X2 in the circumferential direction. A tip end surface 844W of the tooth tip part 844 on the inner side Y2 in the radial direction faces the rotor 200 and defines (in part) a space in which the rotor 200 is rotatably disposed. The wall surface of the first flange 844F1 on the outer side Y1 in the radial direction is also referred to as “first outer peripheral surface WE1,” and the wall surface of the second flange 844F2 on the outer side Y1 in the radial direction is also referred to as “second outer peripheral surface WE2”.

The fitting hole 860 is formed in the surface of the stator core segment 800 on the first side Z1 in the axial direction. The fitting hole 860 has a bottom (i.e. it is a blind hole) and has a recessed shape extending toward the second side Z2 in the axial direction. The fitting hole 860 receives (mates with) a projection 715 formed on the first insulation part 71, as will be further described below. The fitting hole 860 is an example of a “fitting-receiving part” according to the present teachings. Note that, a (another) fitting hole that receives (mates with) a projection formed on a second insulation part 72 may also or instead be formed in the surface of the stator core segment 800 on the second side Z2 in the axial direction.

The fitting hole 860 is preferably disposed at a location that is not likely to intersect (interfere) with the magnetic flux (magnetic fields) generated by the stator winding 90. For example, the fitting hole 860 is preferably disposed at the center of the tooth base part 842 in the circumferential direction DX and positioned on the outer side Y1 in the radial direction (radially outward) relative to the tooth base part 842, such as in region AR shown in FIG. 6. With this arrangement of the fitting hole 860, it is possible to reduce the likelihood that the magnetic flux (magnetic fields) passing through the stator core segment 800 will be obstructed (negatively affected) by the projection 715 inserted into the fitting hole 860.

### A4. Configuration of Electrical Insulation Body 70

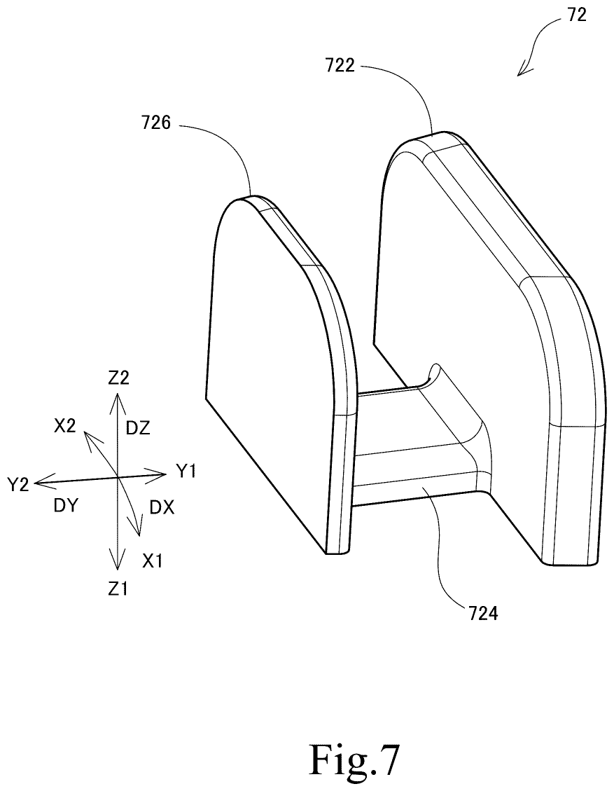

Referring to FIG. 4 as well as FIGS. 7 to 12, the configuration of one of the electrical insulation bodies 70 is described below. In the present embodiment, all of the electrical insulation bodies 70 are preferably formed in an identical manner, but in alternate embodiments one or more of the electrical insulation bodies 70 may be configured differently. As shown in FIG. 4, the electrical insulation body 70 is disposed to cover one of the stator core segments 800 in order to electrically insulate the respective stator winding 90 from the stator core segment 800. Each of the electrical insulation bodies 70 is formed of a polymer (resin) having electrical insulating properties. The electrical insulation body 70 may also be referred to as a “resin bobbin”. As shown in FIG. 4, the (i.e. each) electrical insulation body 70 includes the first insulation part 71, the second insulation part 72, and a third insulation part 73.

FIG. 7 is an explanatory view showing an exterior configuration (shape) of the second insulation part 72. As shown in FIG. 4, the second insulation part 72 is disposed at (on) the second end on the second side Z2 in the axial direction of the stator core segment 800. The second insulation part 72 is formed of, for example, polyethylene sulfide (PPS), syndiotactic polystyrene (SPS), polybutylene terephthalate (PBT), liquid crystal polymer (LCP), or the like. The second insulation part 72 includes a second outer wall part (second radially outward wall part) 722, a second drum part 724, and a second inner wall part (second radially inward wall part) 726.

The second outer wall part 722 is disposed at (on) the (second axial) end on the second side Z2 in the axial direction of the yoke segment 820. The second outer wall part 722 is a plate-shaped member that extends toward the second side Z2 in the axial direction (see e.g., FIG. 4). Note that, the second outer wall part 722 need not cover the entire end portion on the second side Z2 in the axial direction of the yoke segment 820.

The second inner wall part 726 is disposed at (on) the (second axial) end on the second side Z2 in the axial direction of the tooth tip part 844. The second inner wall part 726 is also a plate-shaped member that extends toward the second side Z2 in the axial direction (see e.g., FIG. 4) and is disposed to face (be parallel to) the second outer wall part 722. The width of the second inner wall part 726 along the circumferential direction DX is substantially the same as the width of the tooth tip part 844 along the circumferential direction DX (see e.g., FIG. 2).

The second drum part 724 is disposed at (on) the (second axial) end portion on the second side Z2 in the axial direction of the tooth base part 842. The second drum part 724 extends along the radial direction DY and connects the second outer wall part 722 and the second inner wall part 726. The second drum part 724 electrically insulates the (second axial) end portion on the second side Z2 in the axial direction of the stator core segment 800 from the stator winding 90.

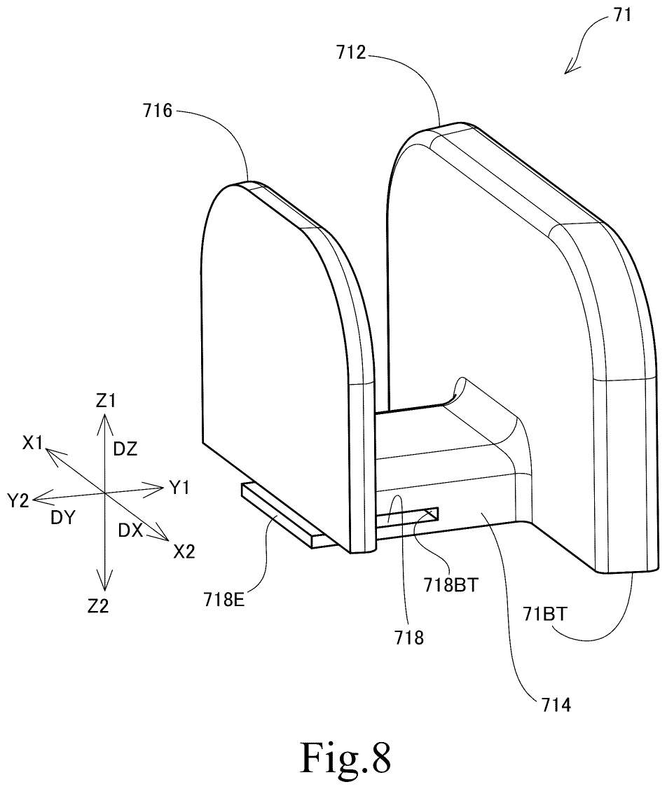

FIG. 8 is an explanatory view showing an exterior configuration (shape) of the first insulation part 71 on the first side Z1 in the axial direction. As shown in FIG. 4, the first insulation part 71 is disposed at (on) the (first axial) end on the first side Z1 in the axial direction of the stator core segment 800 (see e.g., FIG. 4). The first insulation part 71 can be formed using (can be composed of), e.g., the same material as that of the second insulation part 72. The first insulation part 71 includes a first outer wall part 712, a first drum part 714, a first inner wall part 716, and a groove (channel, slot) 718.

The first outer wall part 712 is disposed at (on) the (first) end portion on the first side Z1 in the axial direction of the yoke segment 820. The first outer wall part 712 is a plate-shaped member that extends toward the first side Z1 in the axial direction (see e.g., FIG. 4). Note that, the first outer wall part 712 need not cover the entire end portion on the first side Z1 in the axial direction of the yoke segment 820.

The first inner wall part 716 is disposed at (on) the (first axial) end on the first side Z1 in the axial direction of the tooth tip part 844. The first inner wall part 716 is a plate-shaped member that extends toward the first side Z1 in the axial direction (see e.g., FIG. 4) and is disposed to face (be parallel with) the first outer wall part 712. The width of the first inner wall part 716 along the circumferential direction DX is substantially the same as the width of the tooth tip part 844 along the circumferential direction DX (see e.g., FIG. 2).

The first drum part 714 is disposed at (on) the (first axial) end on the first side Z1 in the axial direction of the tooth base part 842. The first drum part 714 extends along the radial direction DY and connects the first outer wall part 712 and the first inner wall part 716. The first drum part 714 electrically insulates the (first axial) end portion on the first side Z1 in the axial direction of the stator core segment 800 from the stator winding 90.

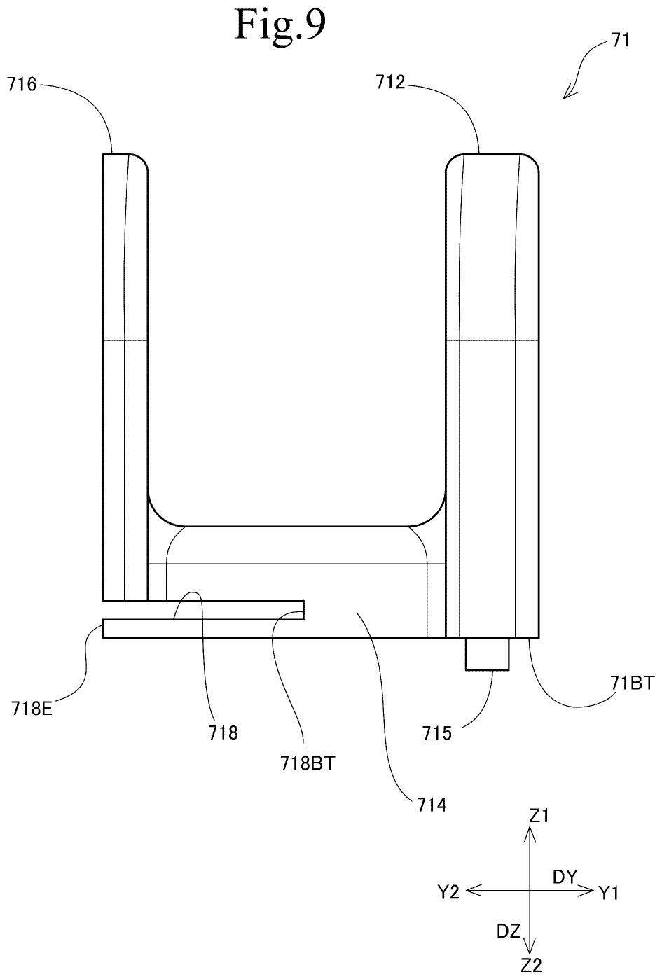

FIG. 9 is an explanatory view showing a configuration (shape) of a side surface of the first insulation part 71. The groove 718 has a recessed shape extending from the inner side Y2 in the radial direction toward the outer side Y1 in the radial direction of the first insulation part 71; i.e. the groove 718 extends from the radially-inward side of the first inner wall part 716 radially outward up to a mid-point (intermediate location) of the first insulating part 71 in the radial direction. In other words, the groove 718 extends straight (i.e. with a rectangular cross-section) from (or from the vicinity of) the end on the second side Z2 in the axial direction of the first inner wall part 716 toward the outer side Y1 in the radial direction.

The wall surface within the groove 718 that is disposed on the outer side Y1 in the radial direction and extends along the circumferential direction DX may be referred to as “bottom wall 718BT”. Thus, the bottom wall 718BT is formed at a position corresponding to an end portion 733Y2 on the inner side Y2 in the radial direction of a connection part 733, which will be further described below. In the present embodiment, the bottom wall 718BT is disposed at or in the vicinity of the midpoint in the radial direction DY of the first drum part 714.

The groove 718 is formed (defined) at a position in the axial direction where its height (h) from lower surface 71BT, which is the surface of the first insulation part 71 on the second side Z2 in the axial direction, is not less than 0.2 mm and not more than 2.0 mm; i.e. 0.2 mm≤h≤2.0 mm. Further, in the circumferential direction DX (more precisely, perpendicular to the radial direction DY), the groove 718 penetrates through the first inner wall part 716 and the first drum part 714 in the first insulation part 71. As a result, as will be further described below, the connection part 733 can be inserted into the groove 718 from an end side 718E on the inner side Y2 in the radial direction toward the outer side Y1 in the radial direction.

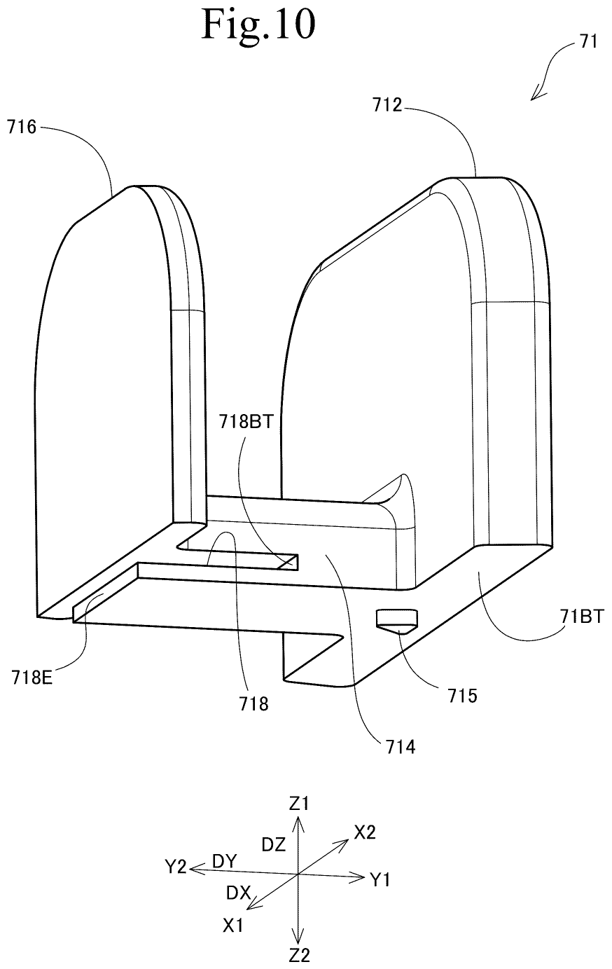

FIG. 10 is an explanatory view showing the exterior configuration of the first insulation part 71 on the second side Z2 in the axial direction. As shown in FIG. 10, in the present embodiment, the first insulation part 71 further includes a projection 715. The projection 715 projects from the lower surface 71BT toward the stator core segment 800 on the second side Z2 in the axial direction. The projection 715 is an example of a “fitting part” according to the present teachings.

The projection 715 is fitted (inserted) into the fitting hole 860 formed on the first side Z1 in the axial direction of the stator core segment 800. By simply fitting (inserting, mating) the projection 715 into the fitting hole 860, the first insulation part 71 can be secured to (fixedly and reliably positioned relative to) the fitting hole 860 when the stator windings 90 are respectively wound around the stator segments 10 and thereafter when the stator core segments 800 are assembled (connected) together to form the segmented stator 100 as shown in FIG. 2.

The projection 715 can be formed in any shape that corresponds (conforms, is complementary) to the shape of the fitting hole 860. In the example shown in FIG. 10, the exterior of the projection 715 has a substantially triangular prism shape. By forming the projection 715 as a triangular prism shape, it is possible, for example, to impede or prevent the first insulation part 71 from rotating about the projection 715 (owing to the form-fit connection) when the projection 715 is fitted (inserted) into the fitting hole 860. It is also possible to improve the accuracy of the positioning of the first insulation part 71 relative to the fitting hole 860 when the first insulation part 71 is secured to the stator core segment 800. In the present example, the projection 715 and the fitting hole 860 are formed (shaped) to provide a form-fit connection, which prevents rotation of the projection 715 (and thus the first insulation part 71) relative to the fitting hole 860 (and thus the segmented core segment 800). However, in addition or in the alternative, the projection 715 and the fitting hole 860 may be formed (shaped) to provide a friction-fit (interference-fit) connection, which prevents any movement of the projection 715 (and thus the first insulation part 71) relative to the fitting hole 860 (and thus relative to the segmented core segment 800).

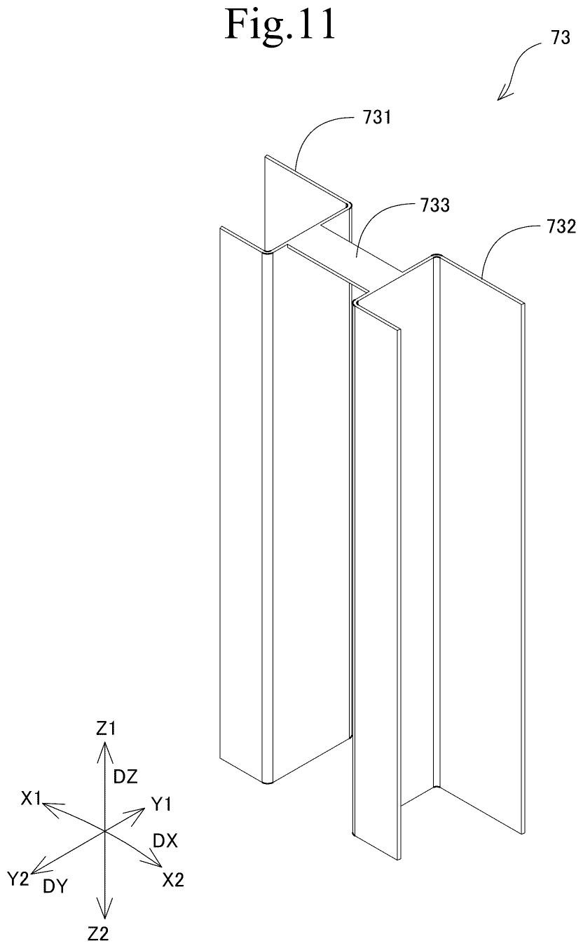

FIG. 11 is an explanatory view showing an exterior configuration (shape) of one of the third insulation parts 73. In the present embodiment, all of the third insulation parts 73 are preferably formed in an identical manner. Each of the third insulation part 73 is comprises (e.g., formed of), for example, polyethylene terephthalate (PET), polyethylene naphthalate (PEN), polyphenylene sulfide (PPS), polyester, or the like. As shown in FIG. 11, the third insulation part 73 includes a first side surface insulation body (sheet) 731, a second side surface insulation body (sheet) 732, and a connection part (sheet) 733.

As shown in FIG. 11, the first side surface insulation body 731 and the second side surface insulation body 732 are elongated sheet- or film-like members (sheet shaped structures) that extend along the axial direction DZ. The first side surface insulation body 731 and the second side surface insulation body 732 have substantially the same shape; however, their positions and orientations relative to the stator core segment 800 are different from each other. The connection part 733 is a sheet- or film-like member (sheet shaped structure) that connects the first side surface insulation body 731 and the second side surface insulation body 732. The thicknesses (t) of the first side surface insulation body 731, the second side surface insulation body 732, and the connection part 733 are, for example, not less than 0.2 mm and not more than 0.5 mm; i.e. 0.2 mm≤t≤0.5 mm.

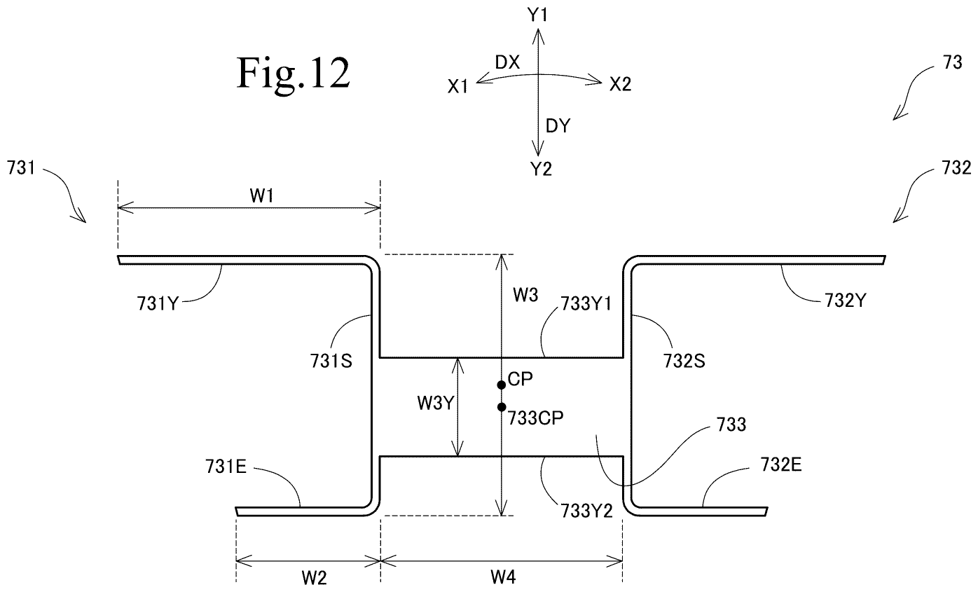

FIG. 12 is a plan view showing a configuration (shape) of the third insulation part 73 on the first side Z1 in the axial direction. The first side surface insulation body 731 includes a first wall part 731Y, a second wall part 731E, and a side wall part 731S.

The width W1 of the first wall part 731Y in the circumferential direction DX is substantially the same as the width of the first inner peripheral surface WY1 of the yoke segment 820 in the circumferential direction DX, which is shown in FIG. 6. The first wall part 731Y is disposed to face the first inner peripheral surface WY1, and covers the entire first inner peripheral surface WY1, as will be further described below.

The width W2 of the second wall part 731E in the circumferential direction DX is substantially the same as the width of the first outer peripheral surface WE1 of the first flange 844F1 in the circumferential direction DX, which is shown in FIG. 6. The second wall part 731E is disposed to face the first outer peripheral surface WE1, and covers the entire first outer peripheral surface WE1, as will be further described below.

The width W3 of the side wall part 731S in the radial direction DY is substantially the same as the width of the first side surface TS1 of the tooth base part 842 in the radial direction DY, which is shown in FIG. 6. The side wall part 731S is disposed to face the first side surface TS1, and covers the entire first side surface TS1. Note that, the “width of the first side surface TS1 in the radial direction DY” refers to the length of the tooth base part 842 in the radial direction DY, which is substantially equal to the distance from the radially-inner peripheral surface of the yoke segment 820 on the inner side Y2 in the radial direction to the radially-outer peripheral surface of the tooth tip part 844 on the outer side Y1 in the radial direction.

The second side surface insulation body 732 includes a first wall part 732Y, a second wall part 732E, and a side wall part 732S. The first wall part 732Y is disposed to face the second inner peripheral surface WY2 of the yoke segment 820 shown in FIG. 6 and covers the second inner peripheral surface WY2. The second wall part 732E is disposed to face the second outer peripheral surface WE2 of the second flange 844F2 shown in FIG. 6 and covers the second outer peripheral surface WE2. The side wall part 732S is disposed to face the second side surface TS2 of the tooth base part 842 shown in FIG. 6 and covers the second side surface TS2. The other configurations of the first wall part 732Y, the second wall part 732E, and the side wall part 732S are the same as those of the first wall part 731Y, the second wall part 731E, and the side wall part 731S of the first side surface insulation body 731. Therefore, detailed explanations of these members are omitted.

As shown in FIG. 12, the connection part 733 extends substantially along the circumferential direction DX (more precisely, perpendicular to the radial direction) and connects the first side surface insulation body 731 and the second side surface insulation body 732. The width W4 of the connection part 733 in the circumferential direction DX is substantially the same as the width of the tooth base part 842 in the circumferential direction DX. Further, the width W3Y of the connection part 733 in the radial direction DY can be set arbitrarily in consideration of factors such as the required strength of the connection part 733, and the position of the connection part 733 disposed in the groove 718. For example, the width W3Y may coincide with (be equal to) the width W3, but the width W3Y is preferably less than the width W3. By increasing the width of the connection part 733, the strength of the connection part 733 can be increased. Note that, the groove 718 is formed to have a shape and position that correspond to the shape and position of the connection part 733.

The connection part 733 is inserted (extends) through the groove 718 of the first insulation part 71 shown in FIGS. 8-10. The connection part 733 inserted (extending) through the groove 718 is an example of “a state in which the connection part 733 is in contact with the first insulation part 71”. The “state in which the connection part 733 is in contact with the first insulation part 71” includes both a state in which the connection part 733 is supported by (on) the first insulation part 71 to an extent that the connection part 733 does not fall off the first insulation part 71, and a state in which the connection part 733 is secured to (held, retained by) the first insulation part 71 so as not to fall off the first insulation part 71. The connection part 733 inserted (extending) through the groove 718 is supported (held, retained) by the first insulation part 71. As a result, when the stator winding 90 is being wound around the stator core segment 800 on which the first insulation part 71, the second insulation part 72, and the third insulation part 73 have been disposed, it is possible to impede or prevent the first side surface insulation body 731 and the second side surface insulation body 732 from falling off the stator core segment 800.

FIG. 12 shows center 733CP of the connection part 733, an end portion 733Y1 of the connection part 733 on the outer side Y1 in the radial direction, and an end portion 733Y2 of the connection part 733 on the inner side Y2 in the radial direction. In the present embodiment, the “center 733CP of the connection part 733” refers to the center of the outer shape of the connection part 733 in the radial direction DY as viewed in a top view. However, the “center 733CP of the connection part 733” may also refer to the center of the connection part 733 in the radial direction DY. Note that, in the present embodiment, the end portion 733Y 1 is disposed to be in contact with the bottom wall 718BT of the groove 718 in a state in which the connection part 733 is inserted (extends) through the groove 718. In this manner, positioning of the connection part 733 in the groove 718 can be easily performed when the connection part 733 is inserted through the groove 718. Note that, based on the premise that the connection part 733 can be inserted through the groove 718, the connection part 733 and/or the groove 718 may be configured such that the end portion 733Y1 and the bottom wall 718BT do not come in contact with each other.

As shown in FIG. 12, in the radial direction DY, the center 733CP is disposed on the inner side Y2 in the radial direction with respect to the center CP of the tooth base part 842 in the radial direction DY; i.e. the center 733CP is disposed radially inward of the center CP. In other words, the connection part 733 is disposed at a position that is offset toward the inner side Y2 in the radial direction (radially inward) with respect to the center CP of the tooth base part 842. Note that, the “center CP of the tooth base part 842” may be defined by either the center of the side wall part 731S of the first side surface insulation body 731 in the radial direction DY or the center of the side wall part 732S of the second side surface insulation body 732 in the radial direction DY. In the present embodiment, the center of the side wall part 731S of the first side surface insulation body 731 in the radial direction DY and the center of the side wall part 732S of the second side surface insulation body 732 in the radial direction DY coincide with each other, but they may differ in other embodiments of the present teachings.

Here it is noted that, if (hypothetically speaking) the center 733CP of the connection part 733 were to (instead) coincide with the center CP of the tooth base part 842, the connection part 733 would then have a shape that is line-symmetrical about the circumferential direction DX passing through the center CP. In this hypothetical embodiment, if the third insulation part 73 is mistakenly oriented in the opposite (incorrect) direction along the radial direction DY; that is, if the end portion 733Y 1 and the end portion 733Y2 are arranged in reverse, it may still be possible to insert the connection part 733 through the groove 718. That is, in this case, the third insulation part 73, even though it is in the reversed (incorrect) orientation, may still be disposed in the stator core segment 800. In this case, the end portion 733Y2, instead of the end portion 733Y1, will come into contact with the bottom wall 718BT of the groove 718.

To avoid this potential problem, in the present embodiment, the center 733CP of the connection part 733 is offset toward the inner side Y2 in the radial direction (radially inward) from the center CP of the tooth base part 842. Therefore, for example, if the orientation of the third insulation part 73 is mistakenly reversed along the radial direction DY, the connection part 733 will be positioned offset toward the outer side Y1 in the radial direction with respect to the center CP. In other words, the connection part 733 will be offset toward the side opposite the side of the correct position. Therefore, when the connection part 733 is inserted through the groove 718, the end portion 733Y2 of the connection part 733 will be blocked by the bottom wall 718BT of the groove 718. As a result, the third insulation part 73 cannot be attached to the first insulation part 71 in the reversed (incorrect) orientation, and thus the first insulation part 71 and the third insulation part 73 are not attachable to (disposable on) the stator core segment 800 in the reversed (incorrect) orientation. Thus, this configuration reduces the likelihood of or even prevents manufacturing (assembly) errors such as the third insulation part 73 being incorrectly disposed in the reverse orientation with respect to the stator core segment 800. Note that, the center 733CP of the connection part 733 may be offset toward the outer side Y1 in the radial direction (radially outward) with respect to the center CP. In such an embodiment as well, the same effect as above can be obtained.

### A5. Method of Manufacturing Motor 310

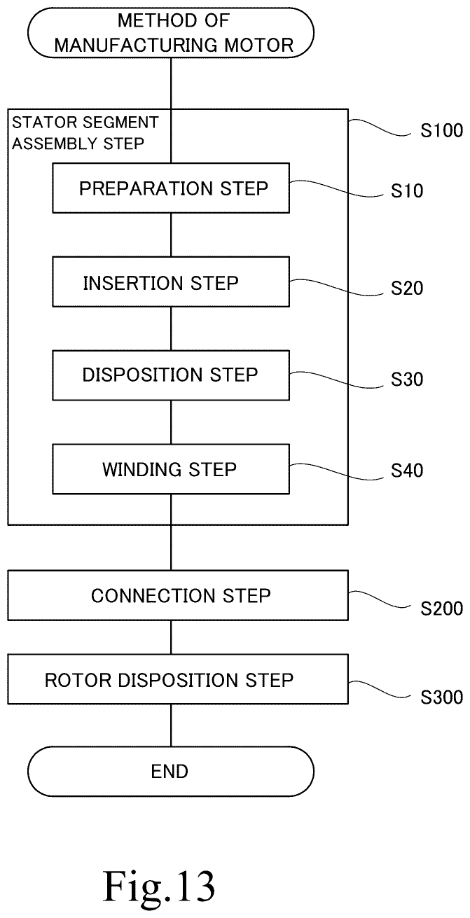

A method of manufacturing the motor 310 of the present embodiment is described below with reference to FIGS. 13 to 15. FIG. 13 is a flow chart showing an exemplary manufacturing process of the motor 310. Thus, the method of manufacturing the motor 310 shown in FIG. 13 is one non-limiting example of a “method of manufacturing an electric motor” according to the present teachings. Such a method of manufacturing an electric motor includes a method of manufacturing a segmented stator.

More specifically, a stator segment assembly step S100 and a connection step S200 are preferably included the manufacturing process of the segmented stator 100. In the stator segment assembly step S100, the stator segments 10, e.g., as shown in FIG. 4, are formed. The stator segment assembly step S100 includes a preparation step S10, an insertion step S20, a disposition step S30, and a winding step S40. In the preparation step S10, the electrical insulation bodies 70, which each include the first insulation part 71, the second insulation part 72, and the third insulation part 73, as well as the stator core segments 800, are prepared or provided (e.g., obtained from a third party).

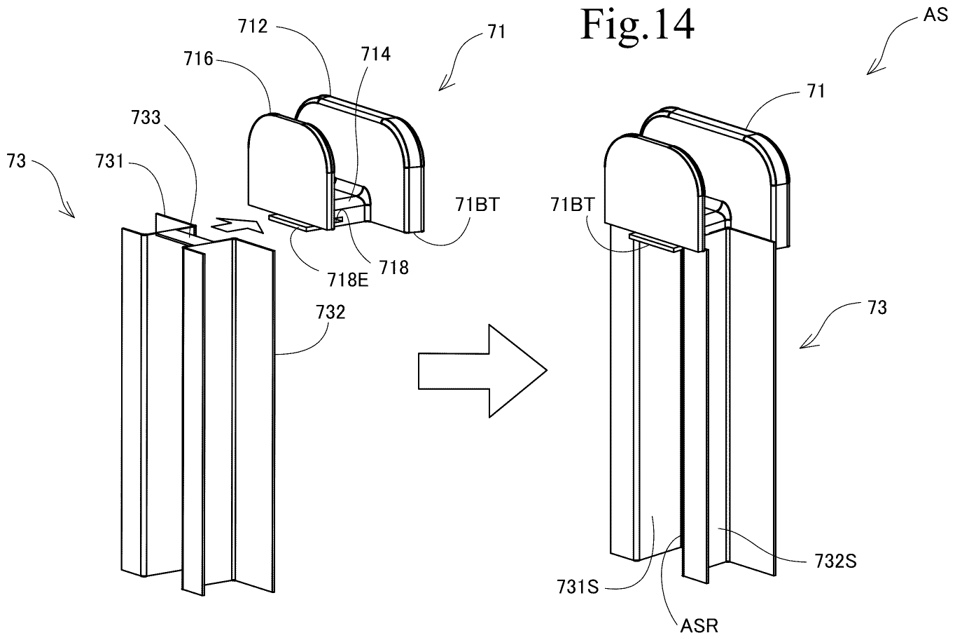

FIG. 14 is an explanatory view showing an overview of the insertion step S20. As shown in FIG. 14, in the insertion step S20, an assembly AS is formed by inserting (placing) the connection part 733 of the third insulation part 73 into the groove 718 of the first insulation part 71 as can be seen on the left side of FIG. 14. In the assembly AS, a recess ASR, which is defined by the side wall part 731S, the side wall part 732S, and the lower surface 71BT, is formed between the first side surface insulation body 731 and the second side surface insulation body 732 as can be seen on the right side of FIG. 14.

Referring back to FIG. 13, in the disposition step S30, the assembly AS and the second insulation part 72 are attached to (placed on) the stator core segment 800. Specifically, the assembly AS shown in FIG. 14 is disposed on the first side Z1 in the axial direction of the stator core segment 800. The assembly AS is moved (slid) toward the second side Z2 in the axial direction while holding the stator core segment 800 stationary, whereby the tooth base part 842 of the stator core segment 800 is inserted into the recess ASR of the assembly AS shown in FIG. 14. In this state, the assembly AS is further moved (slid) relative to the stator core segment 800, whereby the projection 715 of the first insulation part 71 is then inserted into the fitting hole 860 of the stator core segment 800. As a result, as shown in FIG. 4, the first insulation part 71 is secured on the first side Z1 in the axial direction of the stator core segment 800, and the assembly AS is secured to the stator core segment 800. In this state, the first side surface insulation body 731 of the third insulation part 73 is fixed so as to cover the first inner peripheral surface WY1 of the yoke segment 820, the first outer peripheral surface WE1 of the first flange 844F1, and the first side surface TS1 of the tooth base part 842. Likewise, the second side surface insulation body 732 of the third insulation part 73 is fixed so as to cover the second inner peripheral surface WY2 of the yoke segment 820, the second outer peripheral surface WE2 of the second flange 844F2, and the second side surface TS2 of the tooth base part 842. The second insulation part 72 is disposed on the second side Z2 in the axial direction of the stator core segment 800.

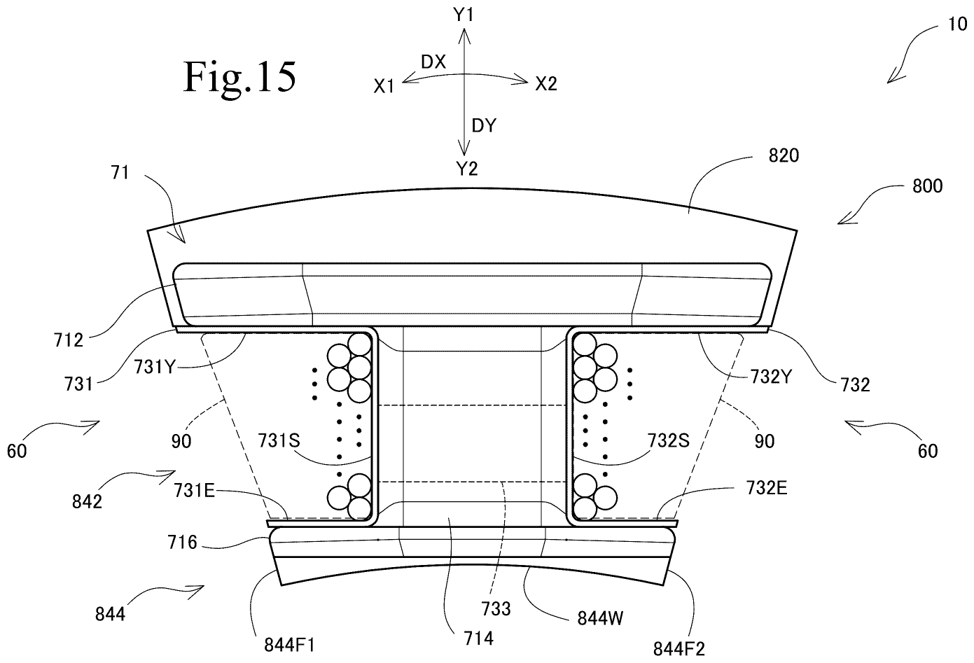

FIG. 15 is an explanatory view showing an overview of the winding step S40. In the winding step S40, the stator winding 90 is wound onto (around) the stator core segment 800 with the assembly AS and the second insulation part 72 disposed thereon, i.e., the stator core segment 800 with the electrical insulation body 70 attached thereto, by using a concentrated winding method.

The stator winding 90 is wound, for example, starting from at or in the vicinity of the connection point between the tooth base part 842 and the yoke segment 820, then continuing on the tooth base part 842 along the inner side Y2 in the radial direction to reach the tooth tip part 844. As a result, one layer of the stator winding 90 is formed. Subsequently, a second layer of the stator winding 90 is formed extending from the tooth tip part 844 toward the yoke segment 820 on the outer side Y1 in the radial direction. In this manner, a coil is formed by winding the stator winding 90 around the tooth base part 842 a predetermined number of times. As a result, the stator segment 10 having a stator winding (coil) 90 wound thereon is completed. As shown in FIG. 15, the stator winding 90 is electrically insulated from the circumferentially-facing sides of the stator core segment 800 by the first side surface insulation body 731 and the second side surface insulation body 732 (and is also electrically insulated from the axially-facing sides of the stator core segment 800 by the first insulation part 71 and the second insulation part 72).

Referring back to FIG. 13, in the connection step S200, the plurality of stator segments 10 thus formed are annularly connected, e.g., by welding the side surfaces of the stator core segments 800 together or otherwise connecting them. As a result, the segmented stator 100 is formed in a substantially cylindrical shape. In a rotor disposition step S300, the rotor 200 is disposed inside the segmented stator 100, thereby completing the motor 310.

### A6. Effects

As described above, according to the motor 310 of the present embodiment, the third insulation part 73 includes the connection part 733 that connects the first side surface insulation body 731 and the second side surface insulation body 732. The connection part 733 is disposed on the first side Z1 in the axial direction with respect to the tooth base part 842 while being in contact with the first insulation part 71. By using the first insulation part 71 to support (hold, retain) the connection part 733, it is possible to impede or even prevent the first side surface insulation body 731 and the second side surface insulation body 732 from falling off the first insulation part 71. Accordingly, it is possible to reduce the likelihood of or even prevent the first side surface insulation body 731 and the second side surface insulation body 732 of the third insulation part 73 from falling off the stator core segment 800 during winding of the stator winding 90.

According to the motor 310 of the present embodiment, the first insulation part 71 includes the groove (channel, slot) 718 having a recessed shape extending from the inner side Y2 in the radial direction toward the outer side Y1 in the radial direction of the first insulation part 71 (i.e. extending radially outwardly). The groove 718 penetrates through the first insulation part 71 at least substantially along the circumferential direction DX (more precisely, perpendicular to the radial direction DY). The connection part 733 is disposed in the groove 718 in a state in which the connection part 733 has been inserted through the groove 718 from the first side X1 in the circumferential direction to the second side X2 in the circumferential direction. By simply inserting the connection part 733 into the groove 718, the connection part 733 can be supported (held, retained) by the first insulation part 71. Since the connection part 733 is supported (held, retained) by the groove 718, it is possible to reduce the likelihood of or even prevent the first side surface insulation body 731 and the second side surface insulation body 732 of the third insulation part 73 from falling off the stator core segment 800 during winding of the stator winding 90.

According to the motor 310 of the present embodiment, the projection 715 that projects toward the stator core segment 800 is formed on the lower surface 71BT of the first insulation part 71. The fitting hole 860 that has a shape corresponding (conforming, complementary) to the projection 715 is formed in a surface on the first side Z1 in the axial direction of the stator core segment 800. Thus, by simply fitting (inserting) the projection 715 into the fitting hole 860, the first insulation part 71 can be secured to the stator core segment 800 when the stator segment 10 is assembled. Accordingly, by performing a simple method, it is possible to reduce the likelihood of or even prevent the first insulation part 71 from falling off the stator core segment 800 during the winding of the stator winding 90.

According to the motor 310 of the present embodiment, the center 733CT in the radial direction DY of the connection part 733 is disposed on the inner side Y2 in the radial direction DY with respect to the center CP in the radial direction DY of the side wall part 731S of the first side surface insulation body 731 and the side wall part 732S of the second side surface insulation body 732. Therefore, it is possible to reduce the likelihood of or even prevent manufacturing (assembly) errors such as the third insulation part 73 being incorrectly disposed in the reverse orientation with respect to the stator core segment 800 in the radial direction DY.

### B. Second Embodiment

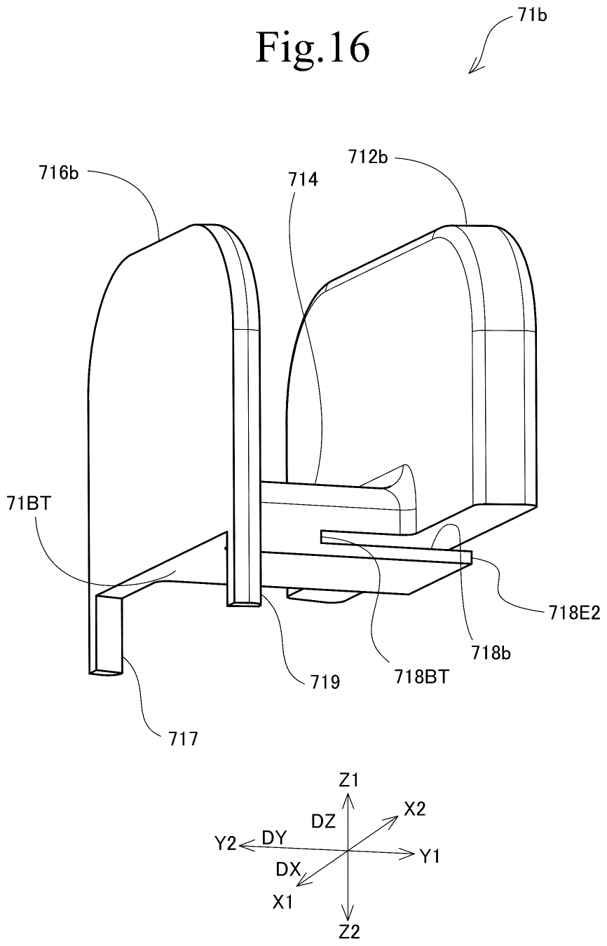

FIG. 16 is an explanatory view showing an exterior configuration (shape) of a first insulation part 71b provided in a stator segment 10 of a motor 310 according to a second embodiment. The first insulation part 71b differs from the first insulation part 71 described in the first embodiment in that the first insulation part 71b includes a first outer wall part 712b in place of the first outer wall part 712, includes an first inner wall part 716b in place of the first inner wall part 716, and includes a groove (channel, slot) 718b in place of the groove 718; the rest of the configuration is the same as that of the first insulation part 71.

The groove 718b is formed (extends) in a direction different from the direction of the groove 718 described in the first embodiment. More specifically, the groove 718b extends straight from (or in vicinity of) the end side on the second side Z2 in the axial direction of the first outer wall part 712b toward the inner side Y2 in the radial direction, reaching approximately the midpoint of the first drum part 714 in the radial direction. That is, in the present embodiment, the groove 718b has a recessed shape extending from the outer side Y1 in the radial direction toward the inner side Y2 in the radial direction of the first insulation part 71b; i.e. the groove 718b extends radially inward from the radially outer side of the first insulation part 71b. Therefore, the direction in which the connection part 733 is inserted into the groove 718b is toward the inner side Y2 in the radial direction (i.e. radially inward), which is opposite to the insertion direction (i.e. radially outward) in the first embodiment. Note that, in the present embodiment, the end portion 733Y2 of the connection part 733 comes into contact with the bottom wall 718BT of the groove 718b.

The end portion 718E2 of the groove 718b is formed on the second side Z2 in the axial direction of the first outer wall part 712b. Accordingly, the length of the first outer wall part 712b along the axial direction DZ is shorter than the length of the first outer wall part 712 described above in the first embodiment. Other configurations of the first outer wall part 712b are the same as those of the first outer wall part 712.

The first inner wall part 716b differs from the first inner wall part 716 described in the first embodiment in that the first inner wall part 716b includes a first side projection 717 and a second side projection 719. The width of the first inner wall part 716b along the circumferential direction DX (more precisely, perpendicular to the radial direction) is wider than the width of the first inner wall part 716 by a length corresponding (equal) to the first side projection 717 and the second side projection 719. Specifically, in the first embodiment, as shown in FIG. 15, an example was described in which the first inner wall part 716 has substantially the same width as the width of the tooth tip part 844 along the circumferential direction DX, whereas in the present embodiment, the first inner wall part 716b is wider than the width (width W6, described below) of the tooth tip part 844 along the circumferential direction DX. An end surface on the second side Z2 in the axial direction of the first inner wall part 716b is a portion of the lower surface 71BT.

Referring again to FIG. 16, the first side projection 717 and the second side projection 719 each have a columnar (prism) structure that projects from the end portion on the second side Z2 in the axial direction of the first inner wall part 716b, i.e., the lower surface 71BT, toward the second side Z2 in the axial direction. The first side projection 717 is provided at (extends from) the lower end portion on the first side X1 in the circumferential direction of the first inner wall part 716b, and the second side projection 719 is provided at the lower end portion on the second side X2 in the circumferential direction of the first inner wall part 716b.

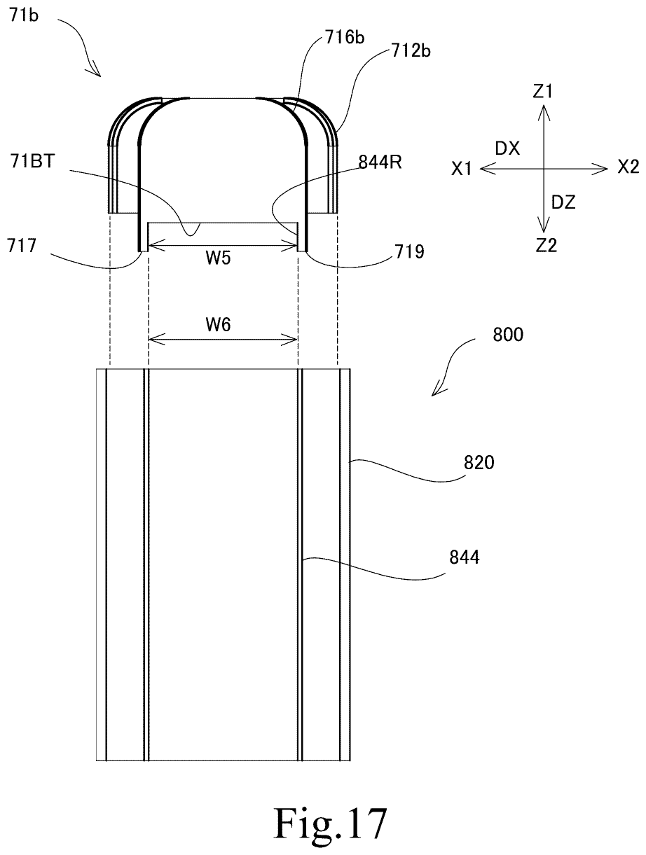

FIG. 17 is an explanatory view showing a configuration (shape) of the first side projection 717 and the second side projection 719. As shown in FIG. 17, the first side projection 717 and the second side projection 719, together with the lower surface 71BT, define a recess 844R.

Distance W5 from the first side projection 717 to the second side projection 719 in the circumferential direction DX is selected to be the same or at least substantially the same as the width W6 of the tooth tip part 844 in the circumferential direction DX. Therefore, when the first insulation part 71b is assembled (placed) onto the stator core segment 800, the first side projection 717 and the second side projection 719 are respectively disposed on the opposite side surfaces of the tooth tip part 844 in the circumferential direction DX. That is, when the first insulation part 71b is assembled (placed) onto the stator core segment 800, the (first) end portion on the first side Z1 in the axial direction of the tooth tip part 844 is fitted (inserted) into the recess 844R.

According to the motor 310 of the present embodiment, the groove 718b has a recessed shape extending from the outer side Y1 in the radial direction to the inner side Y2 in the radial direction of the first insulation part 71b. Therefore, the same effects as those of the first embodiment described above can be achieved, and, for example, structures such as the first side projection 717 and the second side projection 719 can be easily formed on the second side Z2 in the axial direction of the first inner wall part 716b, which is disposed on the inner side Y2 in the radial direction.

With the motor 310 according to the present embodiment, the first insulation part 71b includes the first side projection 717 and the second side projection 719 that project from the end portion on the second side Z2 in the axial direction of the first inner wall part 716b toward the second side Z2 in the axial direction. The first side projection 717 is provided at (extends from) the lower end portion on the first side X1 in the circumferential direction of the first inner wall part 716b, and the second side projection 719 is provided at (extends from) the lower end portion on the second side X2 in the circumferential direction of the first inner wall part 716b. The first side projection 717 and the second side projection 719, together with the lower surface 71BT, define the recess 844R. Accordingly, the first insulation part 71b can be secured to (held or retained by) the stator core segment 800 by simply fitting (inserting) the end portion of the tooth tip part 844 on the second side Z2 in the axial direction into the recess 844R. In addition, it is also possible to impede or even prevent the first insulation part 71b from rotating about the axial direction DZ relative to the stator core segment 800.

Note that, in the present embodiment, the first insulation part 71b does not include the projection 715. However, the first insulation part 71b may include the projection 715. In the present embodiment, for example, even if a projection 715 having a cylindrical shape were to be provided (i.e. instead of a polygonal projection 715), rotation of the first insulation part 71b relative to the stator core segment 800 can be impeded or even prevented by providing the first side projection 717 and the second side projection 719 on the first insulation part 71b.

### C. Third Embodiment

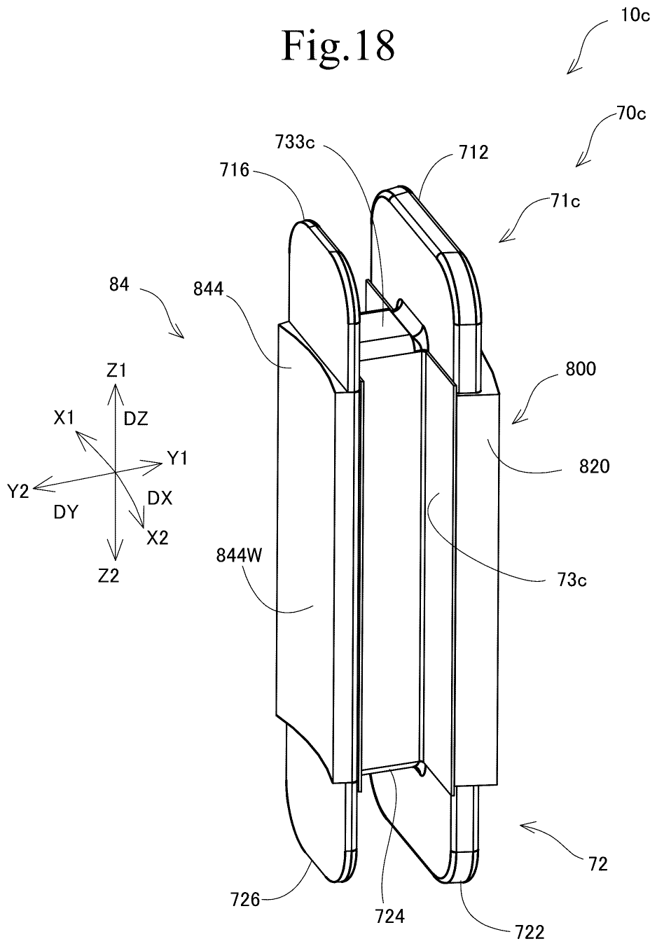

FIG. 18 is an explanatory view showing an exterior configuration (shape) of a stator segment 10c provided in a motor 310 according to a third embodiment. The stator segment 10c differs from the stator segment 10 described in the first embodiment in that the stator segment 10c includes an electrical insulation body 70c in place of the electrical insulation body 70; the rest of the configuration is the same as that of the stator segment 10. The electrical insulation body 70c differs from the electrical insulation body 70 in that the electrical insulation body 70c includes a first insulation part 71c in place of the first insulation part 71, and a third insulation part 73c in place of the third insulation part 73.

The first insulation part 71c differs from the first insulation part 71 in that the first insulation part 71c does not include the groove 718. The first insulation part 71c has the same or at least substantially the same configuration as that of the second insulation part 72 described above.

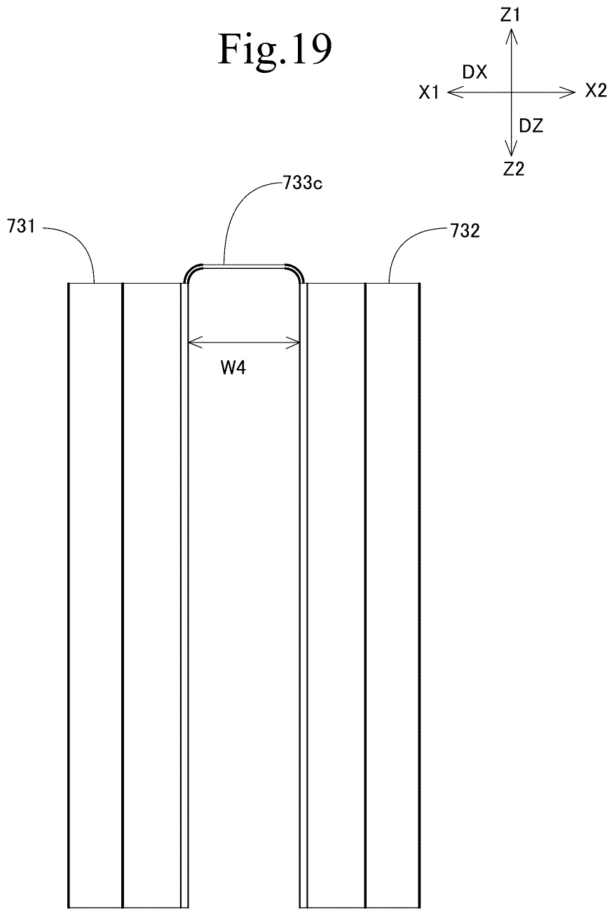

FIG. 19 is an explanatory view showing a configuration (shape) of the third insulation part 73c. The third insulation part 73c differs from the third insulation part 73 described in the first embodiment in that the third insulation part 73c includes a connection part 733c in place of the connection part 733. The width of the connection part 733c in the circumferential direction DX is longer than the width of the connection part 733 in the radial direction DY. Therefore, while bending the third insulation part 73c to form (set) the width W4 (shown in FIGS. 12 and 19) between the first side surface insulation body 731 and the second side surface insulation body 732, the connection part 733c is configured to be capable of being curved (bent) toward the first side Z1 in the axial direction, as shown in FIG. 19.

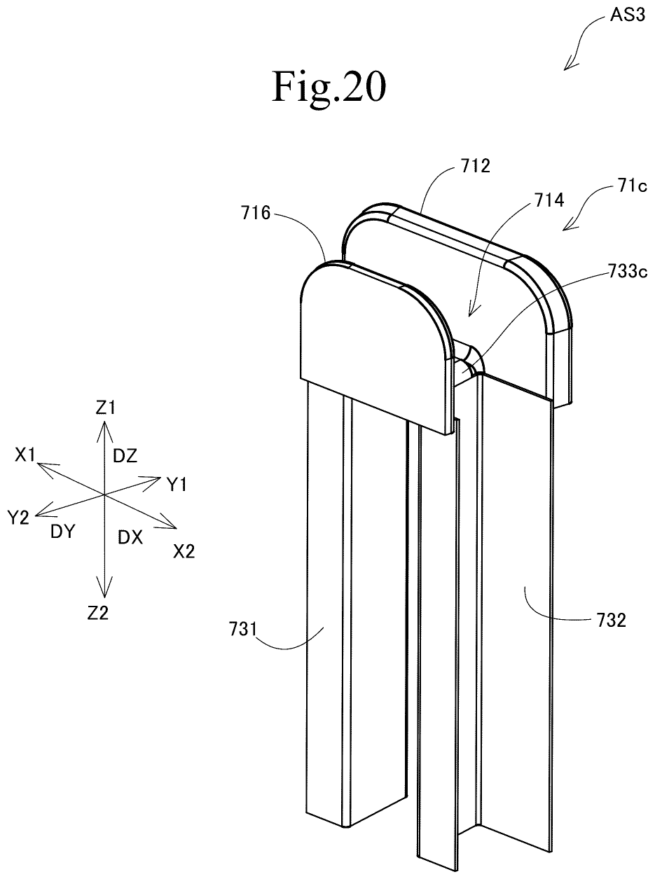

FIG. 20 is an explanatory view showing a configuration of an assembly AS3. As shown in FIG. 20, the assembly AS3 is formed by placing the connection part 733c that has been curved (bent) on the surface on the first side Z1 in the axial direction of the first drum part 714 (e.g., using gravity). The connection part 733c placed on the surface on the first side Z1 in the axial direction of the first drum part 714 is an example of “a state in which the connection part 733 is in contact with the first insulation part 71”. The stator segment 10c of FIG. 18 can be formed, e.g., by attaching the assembly AS3 of FIG. 20 and the second insulation part 72 of FIG. 7 to the stator core segment 800 of FIG. 5 and then winding the stator winding 90 thereon (more specifically, around the tooth base part 842 of the stator core segment 800 and around the first, second and third insulation parts (of any of the preceding embodiments) disposed on (surrounding) the stator core segment 800).

In the motor 310 of the present embodiment, by placing the connection part 733c on the surface on the first side Z1 in the axial direction of the first drum part 714 during the assembly of the stator segment 10c, it can be disposed on the first side Z1 in the axial direction with respect to the tooth base part 842 while being in contact with the first insulation part 71c. In this case, for example, by forming (assembling) the stator segment 10c with the first side Z1 in the axial direction facing upward in the vertical direction, the connection part 733c is supported by the first outer wall part 712 and the first inner wall part 716 by gravity. Accordingly, it is possible to reduce the likelihood of or even prevent the connection part 733c from falling off the first insulation part 71c by utilizing a relatively simple structure.

### D. Fourth Embodiment

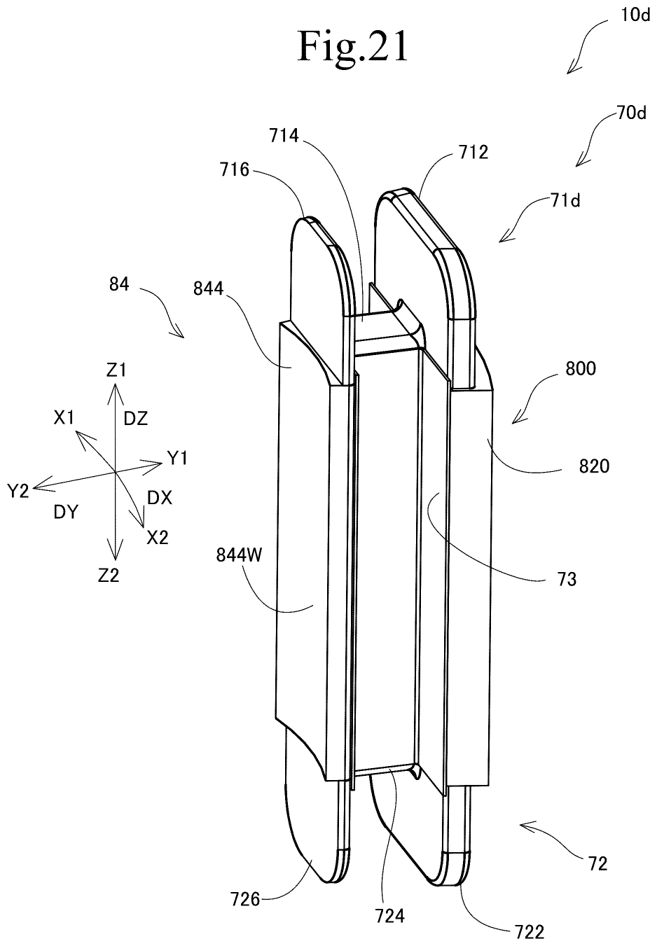

FIG. 21 is an explanatory view showing an exterior configuration of a stator segment 10d provided in a motor 310 according to a fourth embodiment. The stator segment 10d differs from the stator segment 10 described in the first embodiment in that the stator segment 10d includes an electrical insulation body 70d in place of the electrical insulation body 70; the rest of the configuration is the same as that of the stator segment 10. The electrical insulation body 70d is also different in that the electrical insulation body 70d includes a first insulation part 71d in place of the first insulation part 71.

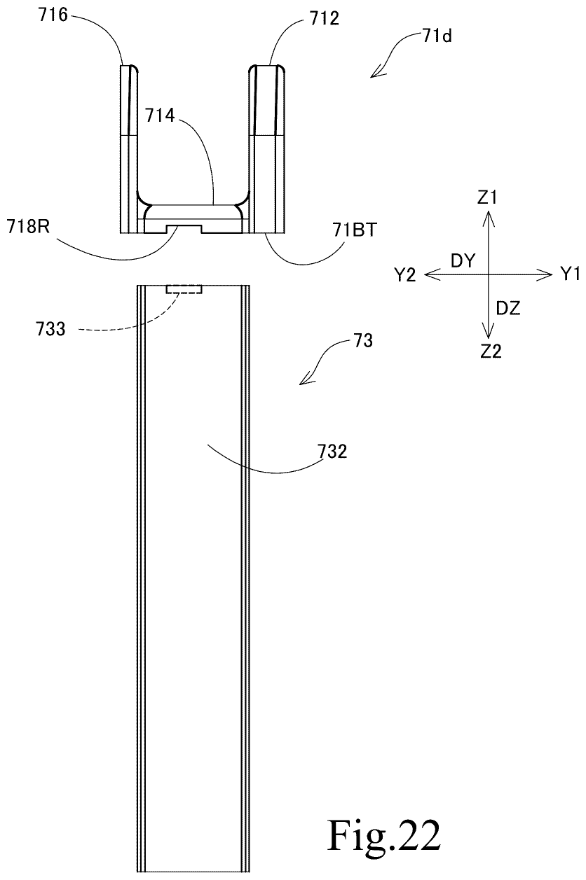

FIG. 22 is an explanatory view showing a configuration (shape) of the first insulation part 71d according to the fourth embodiment. The first insulation part 71d differs from the first insulation part 71 in that the first insulation part 71d includes a recess 718R in place of the groove 718. The recess 718R is formed on the lower surface 71BT of the first insulation part 71d, and penetrates through the first insulation part 71d in the circumferential direction DX (or more precisely, perpendicular to the radial direction DY). The recess 718R has a recessed shape corresponding to the connection part 733 and can accommodate the connection part 733.

An assembly is formed by disposing the connection part 733 in the recess 718R of the first insulation part 71d, and the assembly thus formed is mounted (placed) on the stator core segment 800. That is, in the stator segment 10d, the connection part 733 is held between the end surface on the first side Z1 in the axial direction of the stator core segment 800 and the recess 718R of the first insulation part 71d. The connection part 733 disposed in the recess 718R is an example of “a state in which the connection part 733 is in contact with the first insulation part 71d”.

As described above, in the present embodiment, the connection part 733 is disposed between the stator core segment 800 and the first insulation part 71d by being accommodated in the recess 718R. The third insulation part 73 can be supported (held, retained) by the first insulation part 71d and the stator core segment 800 by simply holding the connection part 733 between the first insulation part 71d and the stator core segment 800. Accordingly, it is possible to reduce the likelihood of or even prevent the first side surface insulation body 731 and the second side surface insulation body 732 of the third insulation part 73 from falling off the stator core segment 800 during winding of the stator winding 90 by a simple method.

Note that, the recess 718R may be formed on (in) the end surface on the first side Z1 in the axial direction of the stator core segment 800 instead of, or together with, the first insulation part 71d. The stator segment 10d may also be configured without the recess 718R. In this case, the connection part 733 may be held, for example, between the lower surface 71BT of the first insulation part 71, which is configured similarly to the second insulation part 72, and the stator core segment 800.

### E. Other Embodiments

(E1) In the first embodiment above, an example was described in which the projection 715, which has an at least substantially triangular prism shape. is formed on the lower surface 71BT of the first insulation part 71, and the fitting hole 860 configured (shaped) to receive (accommodate, mate with) the projection 715 is formed in the surface on the first side Z1 in the axial direction of the stator core segment 800. However, in alternate embodiments according to the present teachings, the fitting hole 860 and the projection 715 may have in any shape other than a triangular prism, as exemplified below (without limitation on the types of shapes that may be utilized with the present teachings).

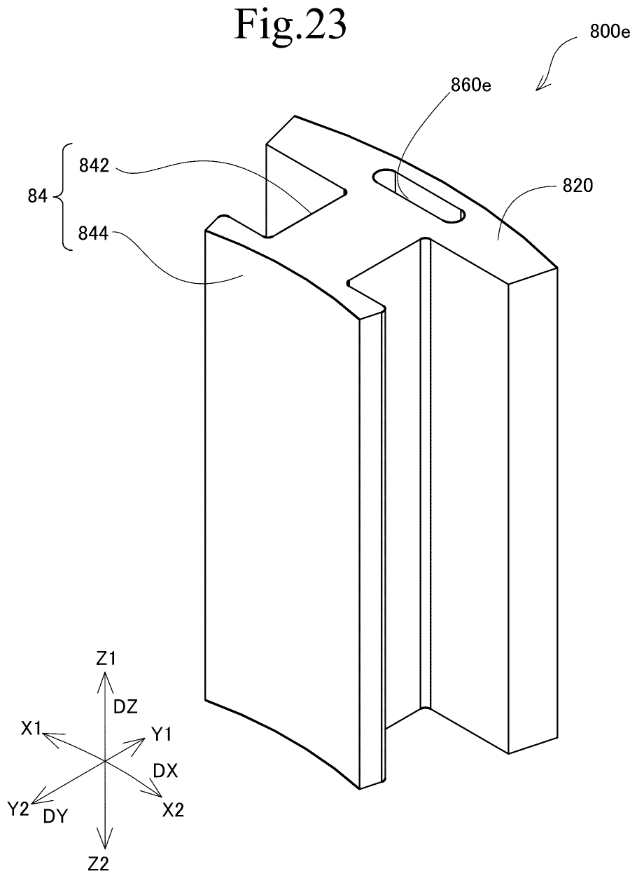

FIG. 23 is an explanatory view showing a configuration (shape) of a fitting hole 860e of a first modified example. In the stator core segment 800e shown in FIG. 23, the fitting hole 860e has an oval shape, which may also be called a stadium shape or slotted hole shape. Examples of the oval shape include the rounded rectangle (stadium shape) shown in FIG. 23, as well as an egg shape, an elongated circle, and an elliptical shape. This configuration also enables the first insulation part 71 to be secured to (held or retained by) the stator core segment 800 by performing a simple method, as in the first embodiment.

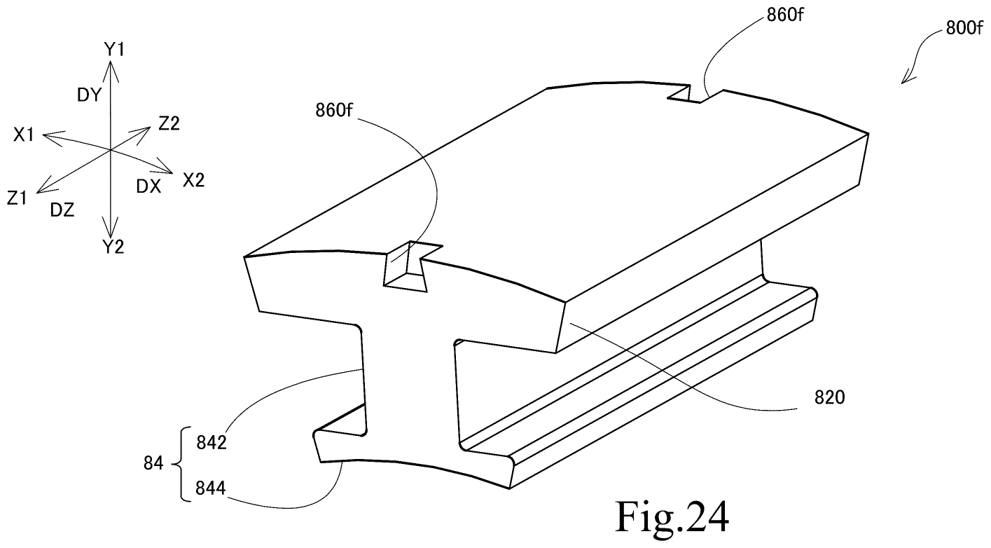

FIG. 24 is an explanatory view showing a configuration (shape) of a cutout 860f of a second modified example. In the stator core segment 800f shown in FIG. 24, the cutout 860f provides communication between the surface on the first side Z1 in the axial direction and the surface on the outer side Y1 in the radial direction. The cutout 860f is formed at (in) the end portion on the outer side Y1 in the radial direction. Accordingly, it is possible to dispose a fitting-receiving part at a position that is less likely to intersect (interfere) with the magnetic flux (magnetic fields) generated by the stator winding 90 while still securing the first insulation part 71 to the stator core segment 800 by performing a simple method. As shown in FIG. 24, the cutout 860f may also be formed at both ends of the stator core segment 800f in the axial direction DZ.

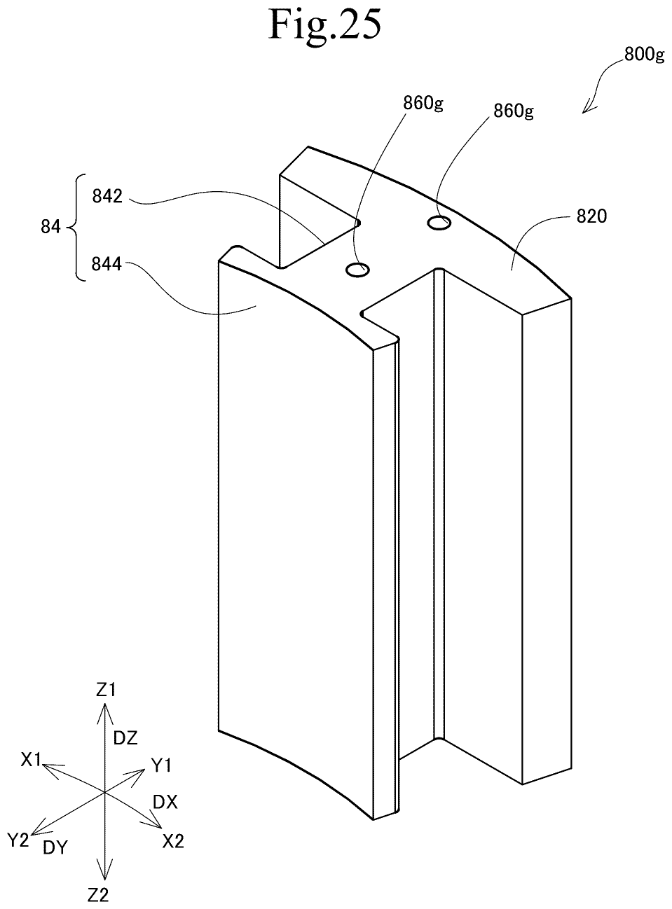

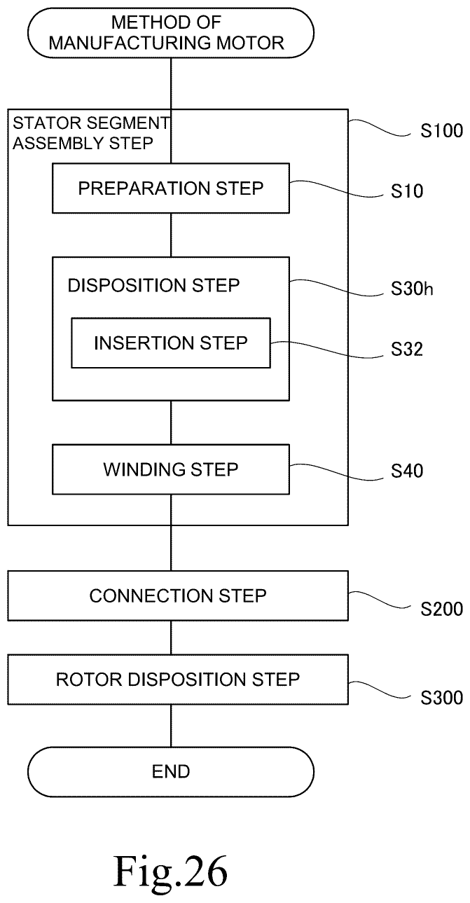

FIG. 25 is an explanatory view showing a configuration (shape) of fitting holes 860g as a third modified example. That is, a plurality of fitting holes 860g may be provided in the stator core segment 800g shown in FIG. 25. Each of the fitting holes 860g has a substantially circular cylindrical shape. In the example shown in FIG. 25, two fitting holes 860g are disposed along the radial direction DY. Accordingly, the first insulation part 71 has two projections 715 disposed so as to be respectively inserted (fitted) into the two fitting holes 860h. Therefore, similar to the first embodiment described above, this configuration also prevents the first insulation part 71 from rotating around the projections 715 (and about the axial direction DZ) when the first insulation part 71 is secured to the stator core segment 800g. Note that, the fitting hole 860e, the cutout 860f, and the fitting holes 860g described above are examples of a “fitting-receiving part”.
(E2) FIG. 26 is a flow chart showing a modified example of the above-described manufacturing process of the motor 310. The method of manufacturing a motor according to the first embodiment was described using an example in which the disposition step S30 is performed after the insertion step S20 has been performed. In contrast, as further described below, the insertion step S32 may be implemented so that it can be performed during a disposition step S30h. In other words, the insertion step S32 and the disposition step S30h may be implemented (performed) as a single step.

In the first embodiment above, in the insertion step S20, an assembly AS is formed by inserting the connection part 733 of the third insulation part 73 into the groove 718 of the first insulation part 71. In the disposition step S30, the assembly AS and the second insulation part 72 are attached to (placed on) the stator core segment 800. In contrast, in the present modified manufacturing process shown in FIG. 26, in the disposition step S30h, the first insulation part 71 and the second insulation part 72 are first attached to the stator core segment 800.

Next, in the insertion step S32, the connection part 733 of the third insulation part 73 is inserted into the groove 718 of the first insulation part 71, which is attached to the stator core segment 800. In a state in which the connection part 733 has been inserted into the groove 718, the first side surface insulation body 731 and the second side surface insulation body 732 of the third insulation part 73 are disposed on the stator core segment 800, for example, by being bent. Specifically, the first side surface insulation body 731 of the third insulation part 73 is fixed so as to cover the first inner peripheral surface WY1 of the yoke segment 820, the first outer peripheral surface WE1 of the first flange 844F1, and the first side surface TS1 of the tooth base part 842. Likewise, the second side surface insulation body 732 of the third insulation part 73 is fixed so as to cover the second inner peripheral surface WY2 of the yoke segment 820, the second outer peripheral surface WE2 of the second flange 844F2, and the second side surface TS2 of the tooth base part 842.

As described above, the order of performing the disposition step and the insertion step may be changed to any desired order. This configuration also has the same effects as those of the first embodiment described above.

The present disclosure is not limited to the structures and method steps described in the above embodiments, and embodiments of the present teachings can be realized according to various other configurations and steps insofar as they do not depart from the gist and scope of the present invention. For example, technical features in the embodiments corresponding to technical features in each of aspects listed in the summary above can be switched, or combined as appropriate, in order to provide additional embodiments of the present teachings, and/or in order to achieve one, some or all of the above-described effects. Further, insofar as those technical features are not described as being essential in the present disclosure, they can be omitted as appropriate.

The present application fully incorporates by reference U.S. patent application Ser. No. ______, which was filed on the same date as the present application, names the same inventors as the present application and has the same title.

### DESCRIPTION OF THE REFERENCE NUMERALS

10, 10c, 10d: stator segment
22: magnet
24: rotor core
60: slot
70, 70c, 70d: electrical insulation body
71, 71b, 71c, 71d: first insulation part
71BT: lower surface
72: second insulation part
73, 73c: third insulation part
80: stator core
82: yoke
84: tooth
90: stator winding
100: segmented stator
200: rotor
300: compressor
301: housing
302: intake port
303: motor chamber
304: fluid communication path
305: discharge port
310: motor
320: compression mechanism
322: fixed scroll
324: movable scroll
330: drive shaft
332: eccentric pin
340: power source circuit
712, 712b: first outer wall part
714: first drum part
715: projection
716, 716b: first inner wall part
717: first side projection
718, 718b: groove
718BT: bottom wall
718E: end portion
718R: recess
719: second side projection
722: second outer wall part
724: second drum part
726: second inner wall part
731: first side surface insulation body
731E: second wall part
731S: side wall part
731Y: first wall part
732: second side surface insulation body
732E: second wall part
732S: side wall part
732Y: first wall part
733, 733c: connection part
733CP: center
733Y1, 733Y2: end portion
800, 800e, 800f, 800g: stator core segment
820: yoke segment
842: tooth base part
844: tooth tip part
844F1: first flange
844F2: second flange
844R: recess
844W: tip end surface
860, 860e, 860g: fitting hole
860f: cutout
718E2: end portion
AS, AS3: assembly
ASR: recess
AX: rotational axis
CP: center
TS1: first side surface
TS2: second side surface
WE1: first outer peripheral surface
WE2: second outer peripheral surface
WY1: first inner peripheral surface
WY2: second inner peripheral surface

1. A motor, comprising:
a segmented stator having a cylindrical shape extending in an axial direction; and
a rotor rotatably disposed within the segmented stator;
wherein:
the segmented stator comprises:
at least one stator core segment including a yoke segment that forms a yoke by annularly coupling a plurality of stator core segments to one another, and a tooth base part extending radially inward from the yoke segment;
an electrical insulation body disposed on the stator core segment; and
a stator winding wound around the tooth base part of the stator core segment via or over the electrical insulation body;
the electrical insulation body comprises:
a first insulation part disposed at a first end on a first side in the axial direction of the stator core segment;
a second insulation part disposed at a second end on a second side in the axial direction of the stator core segment, the second side being opposite to the first side in the axial direction; and
a third insulation part configured to electrically insulate first and second side surfaces of the tooth base part in a circumferential direction from the stator winding;
the third insulation part comprises:
a first side surface insulation body disposed on the first side surface of the tooth base part on a first side in the circumferential direction;
a second side surface insulation body disposed on the second side surface of the tooth base part on a second side in the circumferential direction, the second side surface in the circumferential direction being opposite to the first side surface in the circumferential direction; and
a connection part that connects the first side surface insulation body and the second side surface insulation body; and
the connection part is disposed on the first side in the axial direction with respect to the tooth base part while being in contact with the first insulation part.

2. The motor as defined in claim 1, wherein:
the first insulation part has a fitting part projecting toward the stator core segment;
the first end on the first side in the axial direction of the stator core segment has a fitting-receiving part corresponding to the fitting part; and
the fitting part is mated with the fitting-receiving part.

3. The motor as defined in claim 1, wherein:
a groove is defined in the first insulation part and has a recessed shape extending from an inner side in a radial direction toward an outer side in the radial direction of the first insulation part or a recessed shape extending from the outer side in the radial direction toward the inner side in the radial direction of the first insulation part, the groove penetrating through the first insulation part at least substantially in the circumferential direction; and
the connection part is disposed in the groove while being inserted through the first side in the circumferential direction to the second side in the circumferential direction of the groove so as to be disposed on the first side in the axial direction with respect to the tooth base part while being in contact with the first insulation part.

4. The motor as defined in claim 3, wherein:
the stator core segment includes a tooth tip part that extends continuously to a radially-inward tip end of the tooth base part;
the first insulation part comprises:
an outer wall part disposed at an end portion on the first side in the axial direction of the yoke segment;
a drum part disposed at an end portion on the first side in the axial direction of the tooth base part; and
an inner wall part disposed at an end portion on the first side in the axial direction of the tooth tip part;
the inner wall part comprises:
a first side projection, which is disposed at an end portion on the first side in the circumferential direction of the inner wall part, and projects toward the second side in the axial direction to be in contact with an end portion on the first side in the circumferential direction of the tooth tip part; and
a second side projection, which is disposed at an end portion on the second side in the circumferential direction of the inner wall part, and projects toward the second side in the axial direction to be in contact with an end portion on the second side in the circumferential direction of the tooth tip part.

5. The motor as defined in claim 4, wherein:
the first insulation part has a fitting part projecting toward the stator core segment;
the first end on the first side in the axial direction of the stator core segment has a fitting-receiving part corresponding to the fitting part; and
the fitting part is mated with the fitting-receiving part.

6. The motor as defined in claim 1, wherein the connection part is disposed on an upper surface of the first insulation part so as to be disposed on the first side in the axial direction with respect to the tooth base part while being in contact with the first insulation part.

7. The motor as defined in claim 1, wherein the connection part is disposed between the stator core segment and the first insulation part so as to be disposed on the first side in the axial direction with respect to the tooth base part while being in contact with the first insulation part.

8. The motor as defined in claim 1, wherein:
the stator core segment includes a tooth tip part that extends continuously to a radially-inward tip end of the tooth base part;
the tooth tip part includes a first flange extending from the tooth base part toward the first side in the circumferential direction, and a second flange extending from the tooth base part toward the second side in the circumferential direction;
the first side surface insulation body comprises:
a first wall part disposed to face a first inner peripheral surface of the yoke segment extending from the tooth base part toward the first side in the circumferential direction;
a second wall part disposed to face an outer peripheral surface of the first flange; and
a side wall part disposed to face the side surface of the tooth base part on the first side in the circumferential direction; and
the second side surface insulation body comprises:
a first wall part disposed to face a second inner peripheral surface of the yoke segment extending from the tooth base part toward the second side in the circumferential direction;
a second wall part disposed to face an outer peripheral surface of the second flange; and
a side wall part disposed to face the side surface of the tooth base part on the second side in the circumferential direction.

9. The motor as defined in claim 8, wherein a center of the connection part in the radial direction is disposed either radially outward or radially inward relative to a center of the side wall part of the first side surface insulation body in the radial direction, or radially outward or radially inward relative to a center of the side wall part of the second side surface insulation body in the radial direction.

10. The motor as defined in claim 9, wherein:
the first insulation part has a fitting part projecting toward the stator core segment;
the first end on the first side in the axial direction of the stator core segment has a fitting-receiving part that accommodates the fitting part; and
the fitting part is mated with the fitting-receiving part.

11. The motor as defined in claim 10, wherein:
a groove is defined in the first insulation part and has a recessed shape extending from an inner side in a radial direction toward an outer side in the radial direction of the first insulation part or a recessed shape extending from the outer side in the radial direction toward the inner side in the radial direction of the first insulation part, the groove penetrating through the first insulation part at least substantially in the circumferential direction; and
the connection part is disposed in the groove while being inserted through the first side in the circumferential direction to the second side in the circumferential direction of the groove so as to be disposed on the first side in the axial direction with respect to the tooth base part while being in contact with the first insulation part.

12. A compressor, comprising:
a compression mechanism configured to compress a fluid and to output compressed fluid; and
the motor according to claim 1 configured to drive the compression mechanism.

13. A method of manufacturing a motor, which comprises:
a segmented stator having a cylindrical shape extending in an axial direction and at least one stator core segment having a tooth base part, and a rotor;
the method comprising:
providing at least one electrical insulation body that includes a first insulation part having a groove penetrating through the first insulation part at least substantially in a circumferential direction, a second insulation part, and a third insulation part configured to electrically insulate a first side surface on a first side in the circumferential direction of the tooth base part, which extends radially inward from a yoke segment of the at least one stator core segment, and a second side surface on a second side in the circumferential direction of the tooth base part, from a stator winding;
inserting a portion of the third insulation part into the groove of the first insulation part;
disposing the first insulation part on a first side in the axial direction of the stator core segment, disposing the second insulation part on a second side in the axial direction of the stator core segment, and disposing the third insulation part on the first and second side surfaces of the tooth base part; and
winding the stator winding around the at least one electrical insulation body that is disposed on the at least one stator core segment.

14. A stator segment, comprising:
a stator core segment including a yoke segment that forms a circular segment of a yoke, and a tooth base part extending radially inward from the yoke segment;
an electrical insulation body disposed on the stator core segment; and
a stator winding wound around the tooth base part of the stator core segment via or over the electrical insulation body;
the electrical insulation body comprises:
a first insulation part disposed at a first axial end of the stator core segment;
a second insulation part disposed at a second axial end of the stator core segment, the second axial being opposite to the first axial in an axial direction of the stator segment; and
a third insulation part comprising:
a first side surface insulation body disposed on and electrically insulating a first side surface of the tooth base part on a first side in the circumferential direction;
a second side surface insulation body disposed on and electrically insulating a second side surface of the tooth base part on a second side in the circumferential direction, the second side surface in the circumferential direction being opposite to the first side surface in the circumferential direction; and
a connection part that connects the first side surface insulation body and the second side surface insulation body, the connection part being disposed at the first axial end of the tooth base part while being in contact with the first insulation part.

15. The stator segment as defined in claim 14, wherein:
the first insulation part has a fitting part projecting toward the stator core segment;
the first axial end of the stator core segment has a fitting-receiving part that accommodates the fitting part; and
the fitting part is mated with the fitting-receiving part.

16. The stator segment as defined in claim 15, wherein:
a groove is defined in the first insulation part and has a recessed shape extending radially outward from a radially inward side of the first insulation part or a recessed shape extending radially inward from a radially outward side of the first insulation part, the groove penetrating through the first insulation part at least substantially in the circumferential direction; and
the connection part is disposed in the groove while being inserted through the first side in the circumferential direction to the second side in the circumferential direction of the groove so as to be disposed on the first axial end of the tooth base part while being in contact with the first insulation part.

17. The stator segment as defined in claim 16, wherein:
the stator core segment includes a tooth tip part that extends continuously to a radially-inward tip end of the tooth base part;
the first insulation part comprises:
an outer wall part disposed at an end portion on the first side in the axial direction of the yoke segment;
a drum part disposed at an end portion on the first side in the axial direction of the tooth base part; and
an inner wall part disposed at an end portion on the first side in the axial direction of the tooth tip part;
the inner wall part comprises:
a first side projection, which is disposed at an end portion on the first side in the circumferential direction of the inner wall part, and projects toward the second side in the axial direction to be in contact with an end portion on the first side in the circumferential direction of the tooth tip part; and
a second side projection, which is disposed at an end portion on the second side in the circumferential direction of the inner wall part, and projects toward the second side in the axial direction to be in contact with an end portion on the second side in the circumferential direction of the tooth tip part.
